(19) United States
(12) Patent Application Publication
(10) Pub. No.: US 2016/0232088 A1
(43) Pub. Date: Aug. 11, 2016

(54) Garbage Collection in Storage System with Distributed Processors

(71) Applicant: SanDisk Enterprise IP LLC, Milpitas, CA (US)

(72) Inventors: Vidyabhushan Mohan, San Jose, CA (US); Jack Edward Frayer, Boulder Creek, CA (US)

(21) Appl. No.: 15/098,282

(22) Filed: Apr. 13, 2016

Related U.S. Application Data
(63) Continuation-in-part of application No. 14/597,167, filed on Jan. 14, 2015.
(60) Provisional application No. 62/149,477, filed on Apr. 17, 2015.
(60) Provisional application No. 62/025,857, filed on Jul. 17, 2014.

(51) Int. Cl. G06F 12/02

(52) U.S. Cl. CPC G06F 12/0253; G06F 12/0246; G06F 2212/1044; G06F 2212/2022

(57) ABSTRACT

In a method to perform garbage collection in storage device having a plurality of non-volatile memory (NVM) modules that each include two or more non-volatile memory includes, at a storage controller for the storage device, using status information locally stored in the storage controller with respect to individual NVM modules or individual non-volatile memory devices in the storage device, identifying an NVM module or non-volatile memory device, and sending a garbage collection command to a selected NVM module. The selected NVM module, in accordance with the garbage collection command and status information locally stored in the selected NVM module, selects a memory portion of non-volatile memory in the selected module and initiates garbage collection of valid data in the selected memory portion, which includes copying valid data in the selected memory portion to a target memory portion in the selected module.

### RELATED APPLICATIONS

This application claims priority to U.S. Provisional Patent Application No. 62/149,477, filed Apr. 17, 2015, entitled “High Performance-High Capacity Solid State Drives Having Distributed Processors,” which is hereby incorporated by reference in its entirety. This application is also a continuation-in-part of U.S. patent application Ser. No. 14/597,167, filed Jan. 14, 2015, which claims priority to U.S. Provisional Patent Application No. 62/025,857, filed Jul. 17, 2014, both of which are hereby incorporated by reference in their entireties.

### TECHNICAL FIELD

The disclosed embodiments relate generally to non-volatile memory systems, and in particular, systems and methods for garbage collection (sometimes called data recycling) that are implemented in part in a storage controller and in part in one or more non-volatile memory modules that each include two or more non-volatile memory devices.

### BACKGROUND

Semiconductor memory devices, including flash memory, typically utilize memory cells to store data as an electrical value, such as an electrical charge or voltage. A flash memory cell, for example, includes a single transistor with a floating gate that is used to store a charge representative of a data value. Flash memory is a non-volatile data storage device that can be electrically erased and reprogrammed. More generally, non-volatile memory (e.g., flash memory, as well as other types of non-volatile memory implemented using any of a variety of technologies) retains stored information even when not powered, as opposed to volatile memory, which requires power to maintain the stored information.

As memory systems and storage devices with ever larger quantities of non-volatile memory are designed, performance of management functions, such as mapping between logical and physical addresses, garbage collection and wear leveling, become more challenging due, at least in part, to the sheer quantity of such operations to be performed in order to effectively utility those quantities of non-volatile memory.

### SUMMARY

Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description” one will understand how the aspects of various implementations are used to enable scalable and distributed address mapping of storage devices.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIG. 1A is a block diagram illustrating an implementation of a data storage system, in accordance with some embodiments.

FIG. 1B is a block diagram illustrating an implementation of a data storage system, in accordance with some embodiments.

FIG. 2A is a block diagram illustrating an implementation of a non-volatile memory module, in accordance with some embodiments.

FIG. 2B is a block diagram illustrating an implementation of a management module of a storage device controller, in accordance with some embodiments.

FIG. 2C is a block diagram of storage medium status information stored in the management module of a storage device controller, in accordance with some embodiments.

FIG. 2D is a block diagram of storage medium status information stored in the non-volatile memory controller of a NVM module, in accordance with some embodiments.

FIG. 3 illustrates various logical to physical memory address translation tables, in accordance with some embodiments.

FIGS. 4A-4C illustrate a flowchart representation of a method of enabling scalable and distributed address mapping of non-volatile memory devices in a storage device, in accordance with some embodiments.

FIG. 5 illustrates a flowchart representation of a distributed method of managing garbage collection in a storage device having a storage controller as well as plurality of NVM modules that each include two or more non-volatile memory devices and a module controller for controlling operations performed within the respective NVM module.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The various implementations described herein include systems, methods and/or devices used to enable reliability data management of storage devices. Some implementations include systems, methods and/or devices to retrieve, use or update health information for a portion of non-volatile memory in a storage device.

As the electronics industry progresses, the memory storage needs for electronic devices ranging from smart phones to server systems are rapidly growing. For example, as enterprise applications mature, the capacity of storage devices required for these applications have dramatically increased. As the capacity has increased, correspondingly, the number of non-volatile memory chips inside the storage devices has also increased. As a result of the number of memory chips increasing, the centralized hardware resources inside these storage devices are under higher demand to manage the reliability of the memory.

In order to effectively manage the reliability of non-volatile memories in storage devices, some implementations described herein use scalable techniques of managing reliability data for non-volatile memory (NVM) modules, where each non-volatile memory module includes one or more memory chips, and typically, two or more memory chips. In some implementations, a storage device includes one or more non-volatile memory modules, and typically two or more non-volatile memory modules. For example, as memory storage needs increase, a single storage device increases its memory capacity by adding one or more additional non-volatile memory modules.

(A1) More specifically, in some embodiments, a method of operating a storage device having a plurality of NVM modules that each include two or more non-volatile memory devices, includes, at a storage controller for the storage device, using status information (examples of which are described below) locally stored in the storage controller with respect to individual NVM modules or individual non-volatile memory devices in the storage device, identifying an NVM module or non-volatile memory device, and sending a garbage collection command to a selected NVM module. The selected NVM module is the identified NVM module or the NVM module that includes the identified non-volatile memory device. The method further includes, at the selected NVM module, receiving the garbage collection command sent by the storage controller to the selected NVM module; in accordance with the received garbage collection command, and in accordance with status information locally stored in the selected NVM module, selecting a memory portion of non-volatile memory in the selected module; and initiating garbage collection of valid data in the selected memory portion. Garbage collection of valid data in the selected memory portion includes copying valid data in the selected memory portion to a target memory portion in the selected module. Further, the status information locally stored in the selected NVM module includes status information with respect to smaller memory portions than the status information locally stored in the storage controller.

(A2) In some embodiments of the method of A1, the status information locally stored in the storage controller includes information concerning quantities of unused memory portions in each NVM module or non-volatile memory device in the storage device, the unused memory portions comprising memory portions having no valid data. Further, in such embodiments, identifying an NVM module or non-volatile memory device includes comparing information regarding quantities of unused memory portions in each NVM module of two or more NVM modules of the plurality of NVM modules with one or more predefined thresholds, and identifying the NVM module in accordance with an outcome of the comparing.

(A3) In some embodiments of the method of A1 or A2, the status information locally stored in the storage controller includes information concerning quantities of unused memory portions in each non-volatile memory device in the storage device, the unused memory portions comprising memory portions having no valid data. Further, in such embodiments, identifying an NVM module or non-volatile memory device includes comparing information regarding quantities of unused memory portions in each memory device of two or more non-volatile memory devices in the storage device with one or more predefined unused memory thresholds, and identifying the non-volatile memory device in accordance with an outcome of the comparison.

(A4) In some embodiments of the method of any of A1-A3, the garbage collection command includes one or more memory portion selection parameters for constraining selection of the selected memory portion by the selected NVM module.

(A5) In some embodiments of the method of A4, the status information locally stored in the storage controller includes information concerning quantities of valid data in at least some memory portions in each non-volatile memory device in the storage device, or information concerning quantities of valid data in at least some memory portions in each NVM module of the plurality of NVM modules.

(A6) In some embodiments of the method of A4 or A5, the one or more memory portion selection parameters includes a valid data parameter, and the selected NVM module, when selecting a memory portion of non-volatile memory in the selected module, selects a memory portion consistent with the valid data parameter.

(A7) In some embodiments of the method of A4, the garbage collection command includes device identifying information that identifies a non-volatile memory device from which valid data is to be copied. For example, the garbage collection command identifies a flash memory chip, but not the block within the chip, that is to be garbage collected.

(A8) In some embodiments of the method of any of A1-A7, the garbage collection command includes one or more target memory portion selection parameters for constraining selection of the target memory portion by the selected NVM module.

(A9) In some embodiments of the method of A8, the one or more target memory portion selection parameters includes an age metric or health metric, and the selected NVM module selects the target memory portion of non-volatile memory in the selected module in accordance with the age metric or health metric in the garbage collection command to enable wear-leveling operations within the NVM module.

(A10) In some embodiments of the method of any of A1-A9, the status information locally stored in the selected NVM module includes valid data quantity information, the valid data quantity information including a respective valid data parameter for each memory portion of a plurality of memory portions in each memory device in the selected NVM module. The respective valid data parameter for a respective memory portion in the selected NVM module indicates a quantity of valid data in the respective memory portion in the selected NVM module. In such embodiments, the method includes, at the selected NVM module, selecting a memory portion as the selected memory portion in accordance with the valid data quantity information locally stored in the selected NVM module.

(A11) In some embodiments of the method of any of A1-A10, the status information locally stored in the selected NVM module includes age or health information locally stored in the selected NVM module, the age or health information including an age metric or health metric for each memory portion of a plurality of memory portions in each memory device in the selected NVM module. The respective age metric or health metric for a respective memory portion in the selected NVM module indicates a measurement of age or health of the respective memory portion in the selected NVM module. In such embodiments, the method includes, at the selected NVM module, selecting a memory portion as the target memory portion in accordance with the age or health information locally stored in the selected NVM module.

(A12) In some embodiments of the method of any of A1-A11, the method includes, at the storage controller, updating the status information locally stored in the storage controller with status information received from a respective NVM module of the plurality of NVM modules.

(A13) In some embodiments of the method of A12, the method includes at the storage controller, sending a status update request to a respective NVM module of the plurality of NVM modules, and, at the respective NVM module, in response to receiving the status update request, sending to the storage controller status information based on status information locally stored in the respective NVM module.

(A14) In some embodiments of the method of any of A1-A13, the method further includes, receiving or accessing a host command that specifies an operation to be performed and a logical address corresponding to a portion of non-volatile memory within the storage device, and in response to the host command, at the storage controller for the storage device: mapping the specified logical address to a first subset of a physical address corresponding to the specified logical address, using a first address translation table; and identifying an NVM module of the plurality of NVM modules, in accordance with the first subset of the physical address. Typically, a memory operation command corresponding to the host command is sent by the storage controller to the identified NVM module, and that memory operation command includes the first subset of a physical address corresponding to the specified logical address, and furthermore typically includes the logical address as well. In such embodiments, the method further includes, at the identified NVM module: mapping the specified logical address to a second subset of the physical address corresponding to the specified logical address, using a second address translation table; identifying the portion of non-volatile memory within the identified NVM module corresponding to the second subset of the physical address; and executing the specified operation on the identified portion of non-volatile memory in the identified NVM module.

(A15) In some embodiments of the method of any of A1-A14, the portion of non-volatile memory is an erase block.

(A16) In some embodiments of the method of any of A1-A15, the two or more non-volatile memory devices in each of the plurality of NVM modules comprise three-dimensional (3D) memory devices and circuitry associated with operation of memory elements in the one or more 3D memory devices.

(A17) In some embodiments of the method of A16, the circuitry and one or more memory elements in a respective 3D memory device, of the one or more 3D memory devices, are on the same substrate.

(A18) In some embodiments of the method of any of A1 to A17, the two or more non-volatile memory devices in each of the plurality of NVM modules comprise flash memory devices.

(B1) In another aspect, a storage device includes (1) an interface for coupling the storage device to a host system, (2) a plurality of NVM modules, each NVM module including two or more non-volatile memory devices, and (3) a storage controller having one or more processors, the storage controller configured to: identify, using status information locally stored in the storage controller with respect to individual NVM modules or individual non-volatile memory devices in the storage device, an NVM module or non-volatile memory device in the storage device, and sending a garbage collection command to a selected NVM module, the selected NVM module comprising the identified NVM module or the NVM module that includes the identified non-volatile memory device. The selected NVM module is configured to: (A) receive the garbage collection command sent by the storage controller to the selected NVM module; (B) in accordance with the received garbage collection command, and in accordance with status information locally stored in the selected NVM module, select a memory portion of non-volatile memory in the selected module; and (C) initiate garbage collection of valid data in the selected memory portion, wherein garbage collection of valid data in the selected memory portion includes copying valid data in the selected memory portion to a target memory portion in the selected module. The status information locally stored in the selected NVM module includes status information with respect to smaller memory portions than the status information locally stored in the storage controller.

(B2) In some embodiments of the storage device of B1, the storage device is configured to perform any of the methods A1 to A18.

(B3) In yet another aspect a storage device includes (1) means for coupling the storage device to a host system, (2) a plurality of NVM modules, each NVM module including two or more non-volatile memory devices, and (3) a storage controller having one or more processors, the storage controller including means for identifying an NVM module or non-volatile memory device in the storage device, using status information locally stored in the storage controller with respect to individual NVM modules or individual non-volatile memory devices in the storage device, and means for sending a garbage collection command to a selected NVM module, the selected NVM module comprising the identified NVM module or the NVM module that includes the identified non-volatile memory device. The selected NVM module includes: (A) means for receiving the garbage collection command sent by the storage controller to the selected NVM module; (B) means for selecting a memory portion of non-volatile memory in the selected module in accordance with the received garbage collection command, and in accordance with status information locally stored in the selected NVM module; and (C) means for initiating garbage collection of valid data in the selected memory portion, wherein garbage collection of valid data in the selected memory portion includes copying valid data in the selected memory portion to a target memory portion in the selected module. The status information locally stored in the selected NVM module includes status information with respect to smaller memory portions than the status information locally stored in the storage controller.

(B4) In some embodiments of the storage device of B3, the storage device is configured to perform any of the methods described above.

Numerous details are described herein in order to provide a thorough understanding of the example implementations illustrated in the accompanying drawings. However, some embodiments may be practiced without many of the specific details, and the scope of the claims is only limited by those features and aspects specifically recited in the claims. Furthermore, well-known methods, components, and circuits have not been described in exhaustive detail so as not to unnecessarily obscure more pertinent aspects of the implementations described herein.

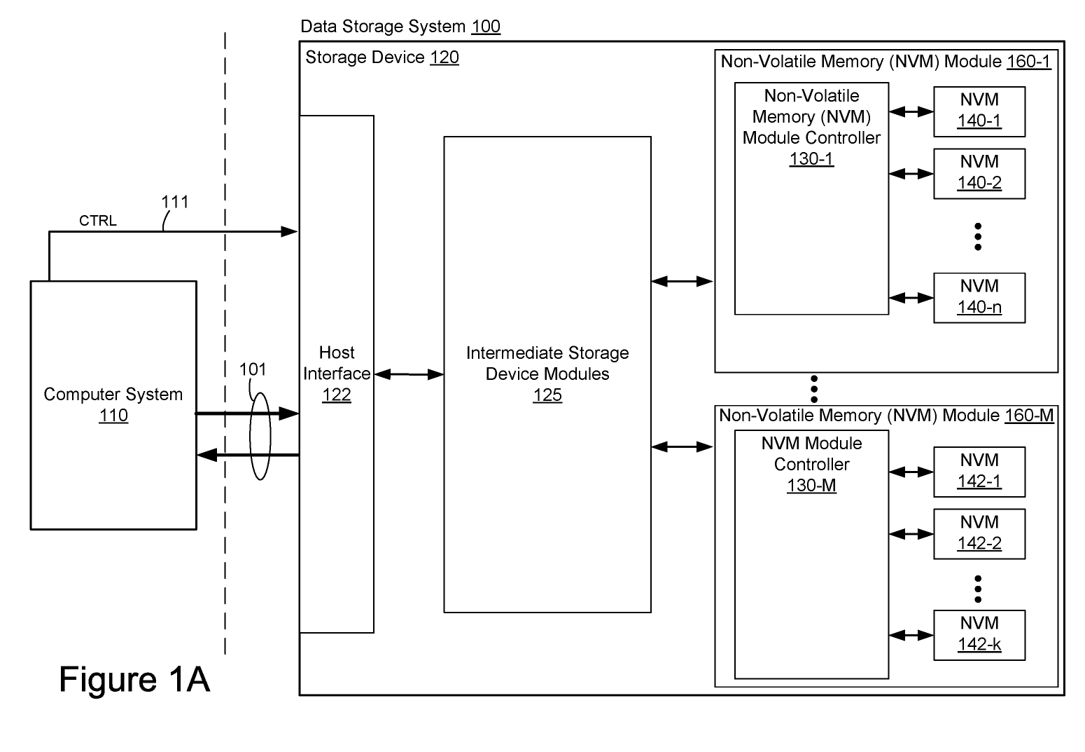

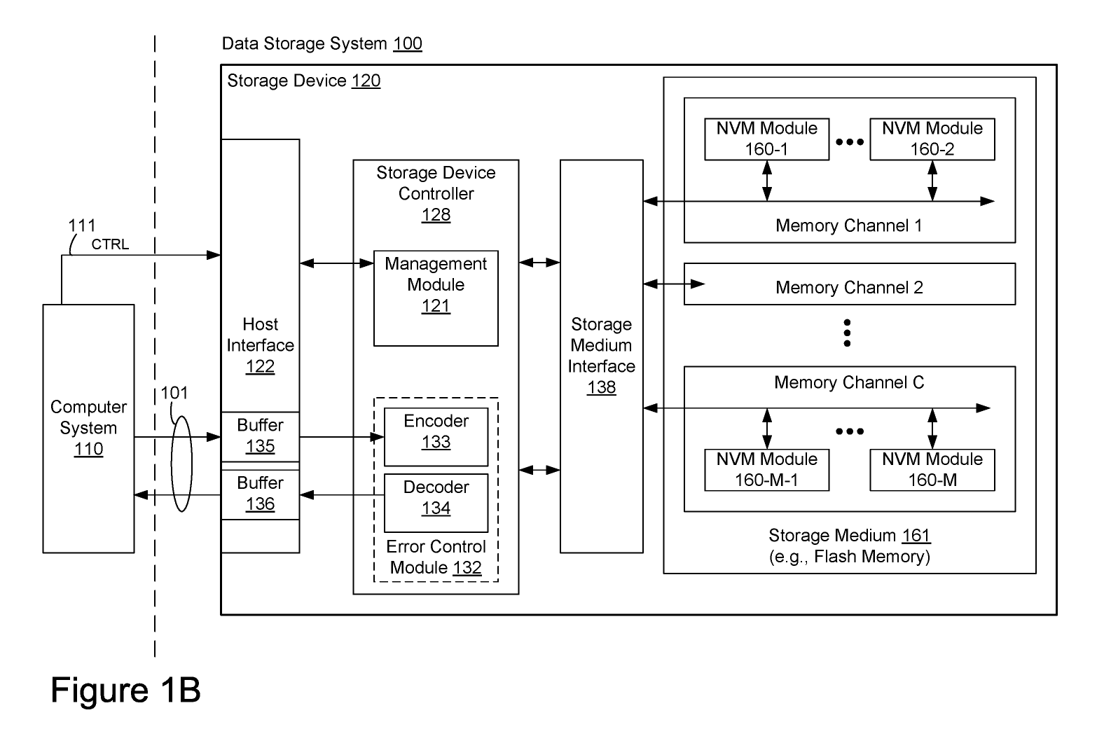

FIG. 1A is a block diagram illustrating an implementation of a data storage system 100, in accordance with some embodiments. While some example features are illustrated, various other features have not been illustrated for the sake of brevity and so as not to obscure more pertinent aspects of the example implementations disclosed herein. To that end, as a non-limiting example, data storage system 100 includes storage device 120, which includes host interface 122, intermediate modules 125 (sometimes collectively called a storage device controller or storage controller) and one or more NVM modules 160. Each NVM module 160 includes one or more NVM module controllers 130 (sometimes herein called NVM controllers 130), and one or more NVM devices (e.g., NVM device(s) 140, 142). In this non-limiting example, data storage system 100 is used in conjunction with computer system 110. In some implementations, NVM devices 140, 142 include NAND-type flash memory or NOR-type flash memory. Further, in some implementations, NVM module controller 130 comprises a solid-state drive (SSD) controller. However, one or more other types of storage media may be included in accordance with aspects of a wide variety of implementations.

Computer system 110 is coupled to storage device 120 through data connections 101. However, in some implementations computer system 110 includes storage device 120 as a component and/or sub-system. Computer system 110 may be any suitable computer device, such as a personal computer, a workstation, a computer server, or any other computing device. Computer system 110 is sometimes called a host or host system. In some implementations, computer system 110 includes one or more processors, one or more types of memory, optionally includes a display and/or other user interface components such as a keyboard, a touch screen display, a mouse, a track-pad, a digital camera and/or any number of supplemental devices to add functionality. Further, in some embodiments, computer system 110 sends one or more host commands (e.g., read commands and/or write commands) on control line 111 to storage device 120, while in other embodiments computer system 110 sends host commands to storage device 120 via data connections 101. In some implementations, computer system 110 is a server system, such as a server system in a data center, and does not have a display and other user interface components.

In some implementations, storage device 120 includes NVM devices 140, 142 (e.g., NVM devices 140-1 through 140-n and NVM devices 142-1 through 142-k) and NVM modules 160 (e.g., NVM modules 160-1 through 160-M). In some implementations, each NVM module of NVM modules 160 include one or more NVM module controllers (e.g., NVM module controllers 130-1 through 130-M). In some implementations, each NVM module controller 130 includes one or more processing units 202 (also sometimes called CPUs, processors, hardware processors, microprocessors or microcontrollers) configured to execute instructions in one or more programs (e.g., in NVM module controllers 130). In some embodiments, NVM devices 140, 142 are coupled to NVM module controllers 130 through connections that typically convey commands in addition to data, and optionally convey metadata, error correction information and/or other information in addition to data values to be stored in NVM devices 140, 142 and data values read from NVM devices 140, 142. For example, NVM devices 140, 142 can be configured for enterprise storage suitable for applications such as cloud computing, or for caching data stored (or to be stored) in secondary storage, such as hard disk drives. Additionally and/or alternatively, flash memory can also be configured for relatively smaller-scale applications such as personal flash drives or hard-disk replacements for personal, laptop and tablet computers. Although flash memory devices and flash controllers are used as an example here, storage device 120 may include any other NVM device(s) and corresponding NVM controller(s).

In some embodiments, each NVM device 140, 142 is divided into a number of addressable and individually selectable blocks. In some implementations, the individually selectable blocks, sometimes called erase blocks, are the minimum size erasable units in a flash memory device. In other words, each block contains the minimum number of memory cells that can be erased simultaneously. Each block is usually further divided into a plurality of pages and/or word lines, where each page or word line is typically an instance of the smallest individually accessible (readable) portion in a block. In some implementations (e.g., using some types of flash memory), however, the smallest individually accessible unit of memory set is a sector, which is a subunit of a page. That is, a block includes a plurality of pages, each page contains a plurality of sectors, and each sector is the smallest unit of memory for reading data from the flash memory device.

For example, each block includes any number of pages, for example, 64 pages, 128 pages, 256 pages or another suitable number of pages. In some types of non-volatile memory, blocks are grouped into a plurality of zones, which can be called block zones. Each block zone can be independently managed to some extent, which increases the degree of parallelism for parallel operations and simplifies management of each NVM device 140, 142.

In some embodiments, intermediate modules 125 include one or more processing units (also sometimes called CPUs, processors, hardware processors, microprocessors or microcontrollers) configured to execute instructions in one or more programs. Intermediate modules 125 are coupled to host interface 122 and NVM modules 160, in order to coordinate the operation of these components, including supervising and controlling functions such as power up, power down, data hardening, reading data from NVM devices 140, 142, writing data to NVM devices 140, 142, erasing data from NVM devices 140, 142, charging energy storage device(s), data logging, communicating between modules on storage device 120 and other aspects of managing functions on storage device 120.

Flash memory devices utilize memory cells to store data as electrical values, such as electrical charges or voltages. Each flash memory cell typically includes a single transistor with a floating gate that is used to store a charge, which modifies the threshold voltage of the transistor (i.e., the voltage needed to turn the transistor on). The magnitude of the charge, and the corresponding threshold voltage the charge creates, is used to represent one or more data values. In some implementations, during a read operation, a reading threshold voltage is applied to the control gate of the transistor and the resulting sensed current or voltage is mapped to a data value.

The terms “cell voltage” and “memory cell voltage,” in the context of flash memory cells, means the threshold voltage of the memory cell, which is the minimum voltage that needs to be applied to the gate of the memory cell's transistor in order for the transistor to conduct current. Similarly, reading threshold voltages (sometimes also called reading signals and reading voltages) applied to a flash memory cells are gate voltages applied to the gates of the flash memory cells to determine whether the memory cells conduct current at that gate voltage. In some implementations, when a flash memory cell's transistor conducts current at a given reading threshold voltage, indicating that the cell voltage is less than the reading threshold voltage, the raw data value for that read operation is a “1” and otherwise the raw data value is a “0.”

FIG. 1B is a block diagram illustrating an implementation of a data storage system 100, in accordance with some embodiments. While some exemplary features are illustrated, various other features have not been illustrated for the sake of brevity and so as not to obscure more pertinent aspects of the example implementations disclosed herein. Furthermore, the descriptions of some aspects of data storage system 100 already described with reference to FIG. 1A are not repeated here. As shown in FIG. 1B, data storage system 100 includes storage device 120, which includes host interface 122, a storage device controller 128 (sometimes herein called a storage controller), and a storage medium 161 coupled to storage device controller 128 by storage medium interface 138. State storage system 100 is used in conjunction with a computer system 110. In some implementations, storage medium 161 includes multiple memory channels (e.g., memory channels 1 to C), each of which includes one more NVM modules 160 (e.g., memory channel 1 includes NVM modules 160-1 and 160-2, and memory channels 1 to C collectively include NVM modules 160-1 to 160-M). As described above with reference to FIG. 1A, each NVM module 160 includes one or more one or more NVM module controllers 130, and one or more NVM devices (e.g., NVM device(s) 140, 142).

In some embodiments, storage medium 161 is NAND-type flash memory or NOR-type flash memory. Further, in some implementations storage device controller 128 is a solid-state drive (SSD) controller. However, other types of storage media may be included in some embodiments.

Computer system 110 is coupled to storage device controller 128 through data connections 101. Other features and functions of computer system 110 and data connections 101 are as described above with respect to FIG. 1A. In some embodiments, host interface 122 includes an input buffer 135 and an output buffer 136. Input and output buffers 135,136 provide an interface to computer system 110 through data connections 101. Similarly, storage medium interface 138 provides storage device controller 128 an interface to storage medium 161. In some implementations, storage medium interface 138 includes read and write circuitry, including circuitry capable of providing reading signals to storage medium 161 (e.g., reading threshold voltages for NAND-type flash memory).

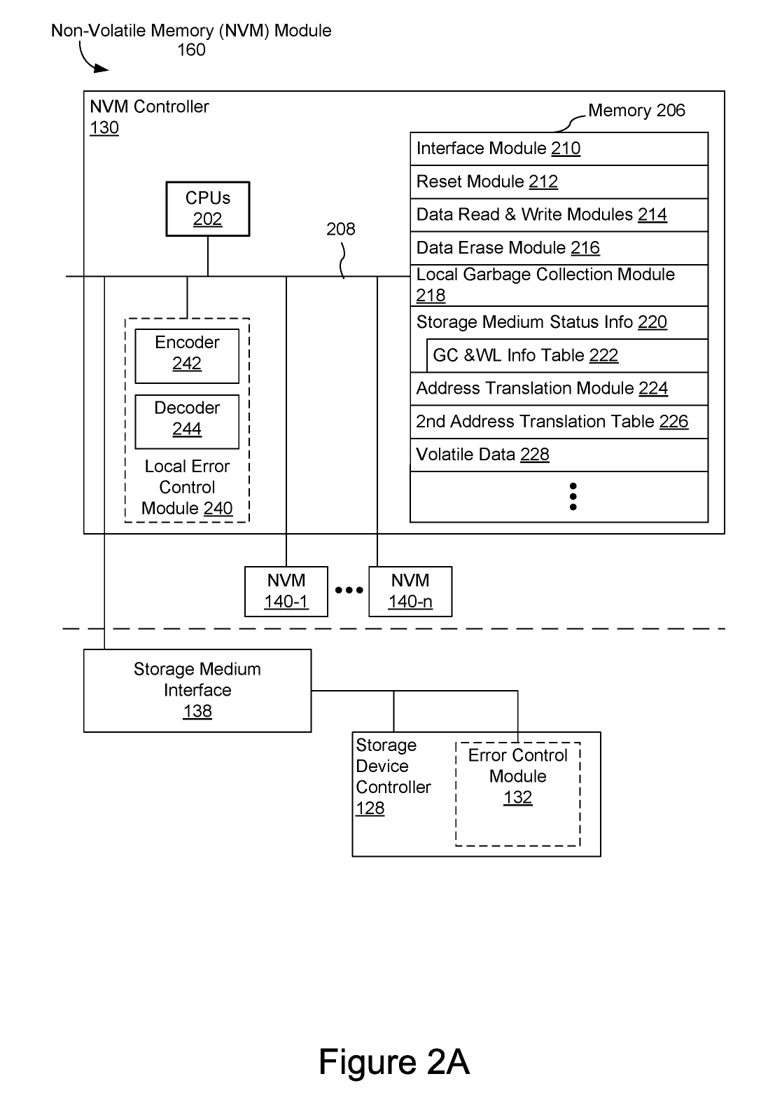

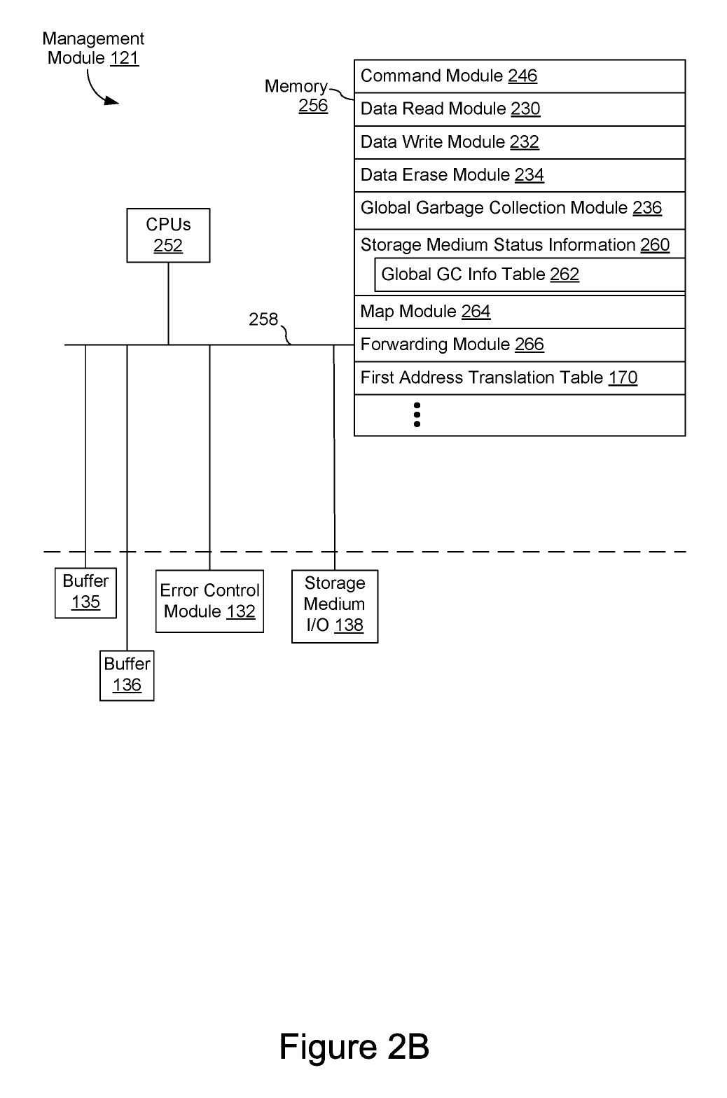

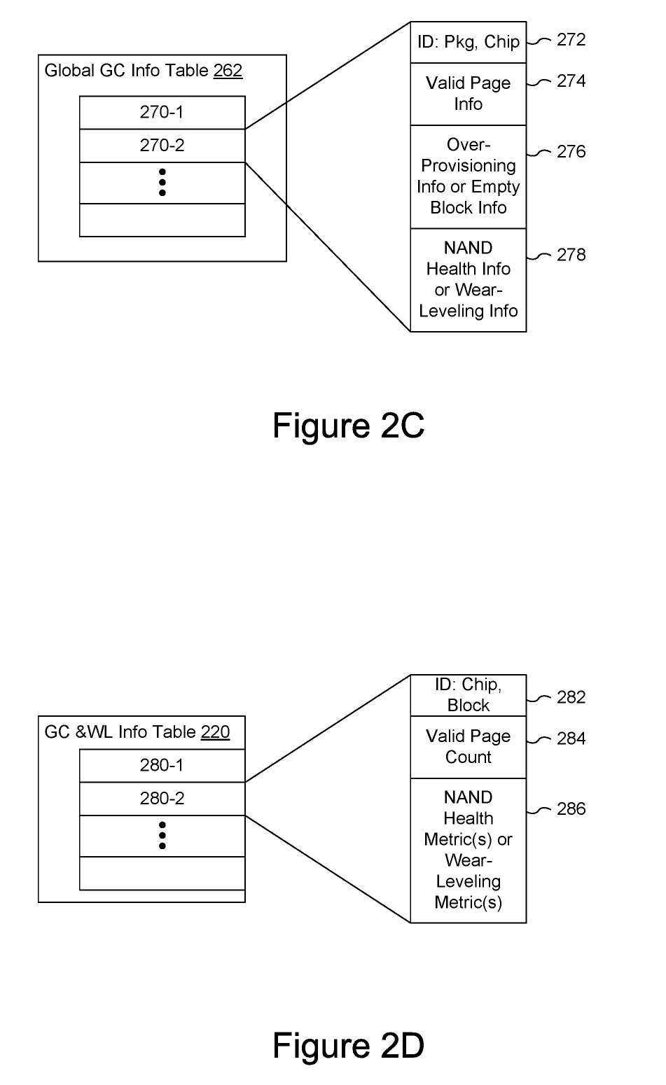

In some implementations, storage device controller 128 includes a management module 121 and, optionally, an error control module 132. Storage device controller 128 may include various additional features that have not been illustrated for the sake of brevity and so as not to obscure more pertinent features of the example implementations disclosed herein, and that a different arrangement of features may be possible. Management module 121 is described in more detail below with reference to FIG. 2B.

In some embodiments, storage device controller 128 does not include error control module 132, and instead each NVM module 160 includes an error control module 240. In those embodiments in which storage device controller 128 does include an error control module 132, error control module 132 is coupled to storage medium interface 138, input buffer 135 and output buffer 136. Error control module 132 is provided to limit the number of uncorrectable errors inadvertently introduced into data. In some embodiments, error control module 132 includes an encoder 133 and a decoder 134. Encoder 133 encodes data by applying an error control code to a set of data (sometimes called host data or unencoded data) to produce a codeword, which is subsequently stored in storage medium 161. In some embodiments, when the encoded data (e.g., one or more codewords) is read from storage medium 161, decoder 134 applies a decoding process to the encoded data to recover the data, and to correct errors in the recovered data within the error correcting capability of the error control code. For the sake of brevity, an exhaustive description of the various types of encoding and decoding algorithms generally available and known to those skilled in the art is not provided herein.

During a write operation, input buffer 135 receives, from computer system 110, data to be stored in storage medium 161. In some embodiments, the data held in input buffer 135 is made available to encoder 133, which encodes the data to produce one or more codewords. The one or more codewords are made available to storage medium interface 138, which transfers the one or more codewords to storage medium 161 in a manner dependent on the type of storage medium being utilized. Alternatively, in some embodiments, the data held in input buffer 135 is available to encoder 242 in the local error control module 240 of the NVM module 160 in which the data is to be stored, and encoder 242 encodes the data to produce one or more codewords.

In some embodiments, during the write operation, management module 121 determines a first subset of a respective physical address for the write operation, and adds that first subset of the respective physical address to an entry in first address translation table 170 (see FIG. 2B), for example the first 24 bits of a 37-bit address. In some embodiments, this first subset of a respective physical address is made available, along with the data or one or more codewords to storage medium interface 138, which transfers this information to storage medium 161 in a manner dependent on the type of storage medium being utilized. In some embodiments, address information is received by management module 121 after the write operation is performed, from storage medium 161 via storage medium interface 138, to update the first address translation table 170. Optionally, storage medium status information is received by management module 121 from storage medium 161, via storage medium interface 138, after the write operation is performed or at other times, to update the storage medium status information 260 (see FIG. 2B) locally stored in management module 121.

A read operation is initiated when computer system (host) 110 sends one or more host read commands on control line 111 or data connections 101 to storage device controller 128, requesting data from storage medium 161. Storage device controller 128 sends one or more read access commands to storage medium 161, via storage medium interface 138, to obtain raw read data in accordance with memory locations (addresses) specified by the one or more host read commands. In some embodiments, storage medium interface 138 provides the raw read data (e.g., comprising one or more codewords) to decoder 134. Alternatively, in some embodiments, a respective NVM module 160 provides the raw read data to decoder 244 (FIG. 2A) in a local error control module 240 of the NVM module. If the decoding is successful, the decoded data is provided to output buffer 136, where the decoded data is made available to computer system 110. In some implementations, if the decoding is not successful, storage device controller 128 may resort to a number of remedial actions or provide an indication of an irresolvable error condition.

In some embodiments, during the read operation, storage device controller 128 sends one or more read access commands to storage medium 161, via storage medium interface 138. In some embodiments, during the read operation, storage device controller 128 looks up in first address translation table 170 (FIG. 2B) a first subset of a first physical address corresponding to the logical address specified by a host read command. Storage device controller 128 then sends a read access command to an NVM module 160 corresponding to the first subset of the first physical address. The read access command typically includes the first subset of the first physical address, and typically also includes the logical address specified by the host read command. In response to the read access command, the NVM module 160 that receives the read access command determines a second subset of the first physical address, by performing a lookup in a second address translation table 226 (FIG. 2A) in the NVM module, and obtains read data from a memory portion specified by the first physical address. The obtained read data is then decoded, by decoder 244 (FIG. 2A) in the NVM module 160, or decoder 134 in storage device controller 128, to produce decoded data that is then returned to computer system (host) 110 via output buffer 136.

FIG. 2A is a block diagram illustrating an implementation of an NVM module 160 (e.g., any of NVM modules 160-1 to 160-M, FIG. 1B), in accordance with some embodiments. NVM module 160 typically includes two or more non-volatile memory devices 140 or 142 and an NVM controller 130, which in turn includes one or more processors 202 (also sometimes called CPUs, processors, hardware processors, microprocessors or microcontrollers) for executing modules, programs and/or instructions stored in memory 206 and thereby performing processing operations, memory 206 (sometimes called controller memory or NVM controller memory), and one or more communication buses 208 for interconnecting these components. As shown, the non-volatile memory devices 140 or 142 in NVM module 160 are coupled to NVM controller 130 by communication busses 208.

Communication buses 208 optionally include circuitry (sometimes called a chipset) that interconnects and controls communications between system components. In some implementations, NVM module 160 is coupled to storage device controller 128, and error control module 132 (if present) by communication buses 208. Memory 206 of NVM controller 130 includes high-speed random access memory, such as DRAM, SRAM, DDR RAM or other random access solid state memory devices, and may include NVM, such as one or more magnetic disk storage devices, optical disk storage devices, flash memory devices, or other non-volatile solid state storage devices. Memory 206 optionally includes one or more storage devices remotely located from NVM controller 130. Memory 206, or alternately the NVM device(s) within memory 206, comprises a non-transitory computer readable storage medium. In some embodiments, memory 206, or the computer readable storage medium of memory 206 stores the following programs, modules, and data structures, or a subset thereof:
interface module 210 that is used for communicating with other components, such as storage device controller 128 and NVM devices 140;
reset module 212 that is used for resetting NVM module 160;
one or more data read and write modules 214, sometimes collectively called a command execution module, used for reading from and writing to NVM devices 140;
data erase module 216 that is used for erasing portions of memory on NVM devices 140;
local garbage collection module 218 that is used to select a memory portion within the NVM module to garbage collect, and perform a garbage collection operation on that memory portion;
local storage medium status information 220, including status information for respective memory portions (e.g., erase blocks) in the non-volatile memory devices 140 in NVM module 160, as described in more detail below; status information 220 is typically stored in one or more tables or other data structures (e.g., a local garbage collection and wear leveling (GC & WL) information table 222) in memory 206;
address translation module 224 for performing address translation operations, including mapping a specified logical address to a second subset of a physical address corresponding to the specified logical address, using second address translation table 226;
second address translation table 226 for associating logical addresses with second subsets of respective physical addresses (e.g., the last 6 bits of 37-bit physical addresses) for respective portions of storage medium 161, FIG. 1B; in some embodiments, for logical addresses corresponding to valid data stored in the NVM module 160, second address translation table 226 stores a subset of the corresponding physical memory address (e.g., the last 6 bits of a 37-bit physical address); and
volatile data 228 including volatile data associated with NVM module 160, and in some embodiments information such as memory operation parameters or portions of second address translation table 226.

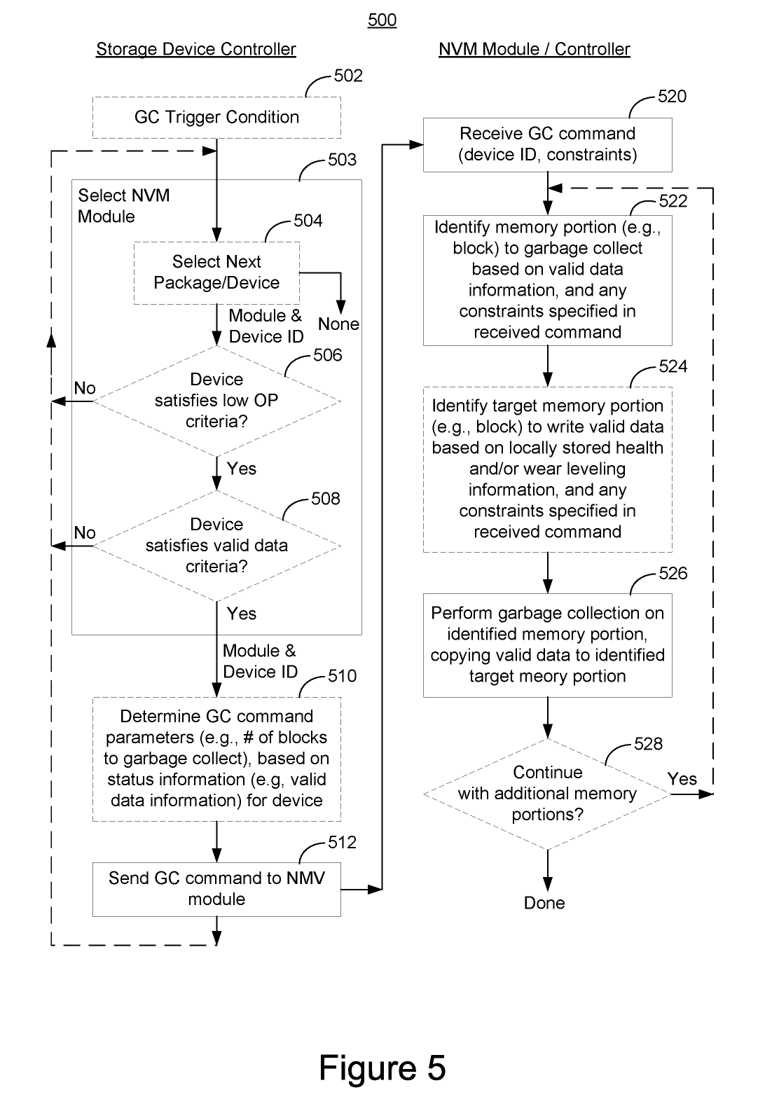

In some embodiments, the local garbage collection module 218 includes instructions for operations such as selecting a memory portion (e.g., an erase block) to garbage collect, consistent with parameters or constraints specified by a garbage collection command received from storage device controller 128, and performing garbage collection on the selected memory portion, as described in more detail below with reference to FIG. 5.

In some embodiments, memory operation parameters comprise one or more of write operation voltage, write operation step voltage, dynamic read parameters or various other operation-dependent bias voltages used while writing data to and/or reading data from non-volatile memory devices 140. In some embodiments, rather than have a standard, static set of memory operation parameters, the memory operation parameters used by NVM controller 130 when performing memory operations are adaptable and customizable to one or more portions of NVM devices 140.

In some embodiments, second address translation table 226 stores subsets of respective physical memory addresses (e.g., the last 6 bits of a 37-bit physical address), along with corresponding logical addresses. In some embodiments, second address translation table 226 is used in combination with a first address translation table (e.g., first address translation table 170, FIG. 2B) to map specified logical addresses into corresponding physical addresses.

In some embodiments, for efficient implementation, second address translation table 226 is indexed by physical addresses and includes entries that map respective physical addresses, in a predefined range of physical addresses, to logical addresses. In some embodiments, the second address translation table 226 further includes a tree structure indexed by logical addresses for locating entries in the second translation table. The tree is, for example, a B-tree for locating entries in the second address translation table, and maps logical addresses, which have been mapped to physical addresses in the predefined range of physical addresses, to entries in the second address translation table. The tree structure provides a fast mechanism for locating the entry in second address translation table 226 corresponding to a specified logical address. Thus, for example, when data storage system 100 (see FIG. 1) is responding to a read command from a host device 110, the storage device controller maps the logical address specified by the read command to a coarse memory portion, and the tree structure is then used to efficiently locate a specific entry in the second address translation table corresponding to that coarse memory portion. The logical address is then mapped to a physical address using physical address information in that entry of second address translation table 226.

In some embodiments, NVM module 160 receives a memory operation command (e.g., from storage device controller 128), or alternatively accesses a memory operation command (e.g., from a command queue), the memory operation command specifying a respective memory operation (e.g., read a page) to be performed on a portion of NVM devices 140, determines the portion of NVM memory, retrieves health information for that portion, modifies one or more memory operation parameters in accordance with the respective memory operation and the retrieved health information, and then performs the respective memory operation.

In some embodiments, NVM module 160 receives a memory operation command (e.g., from storage device controller 128), or alternatively accesses a memory operation command (e.g., in a command queue), the memory operation command specifying a respective memory operation (e.g., read a page or write a page) to be performed on a portion of NVM devices 140, along with a first subset of a corresponding physical address for the memory operation and a first corresponding logical address. In some embodiments, NVM module 160 uses the first corresponding logical address and the first subset of a corresponding physical address (e.g., the 32 most significant bits of a 38-bit address) to determine a second subset of the corresponding physical address (e.g., the 6 least significant bits of the 38-bit address) and determine the complete physical address (e.g., a full 38-bit address).

In some embodiments, a memory operation such as a write or erase operation, or a garbage collection operation, changes the addressing of the respective portion of NVM devices 140. In some embodiments, after performing one of these types of memory operations, NVM module 160 updates the mapping of second address translation table 226, and in some embodiments this updating is performed by data read and write modules 214, or data erase module 216, or local garbage collection module 218. In some embodiments, after performing one of these types of memory operations, a first address translation table stored in the storage device controller (e.g., first address translation table 170, FIG. 2B), is also updated to reflect the addressing change.

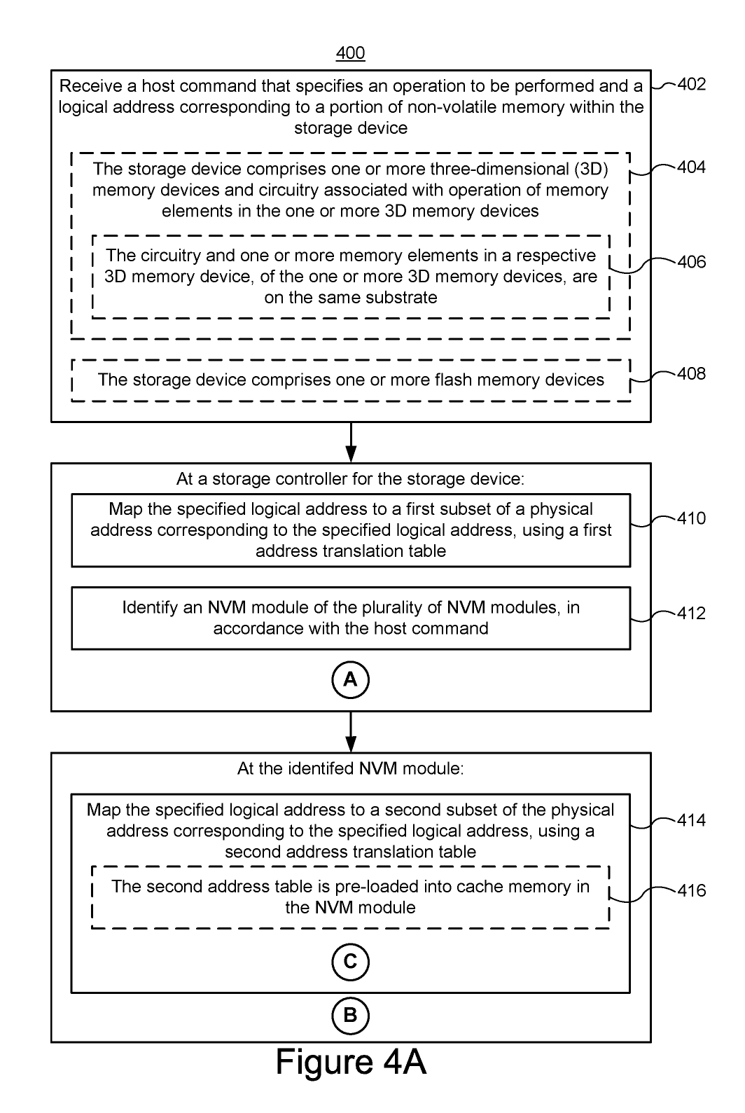

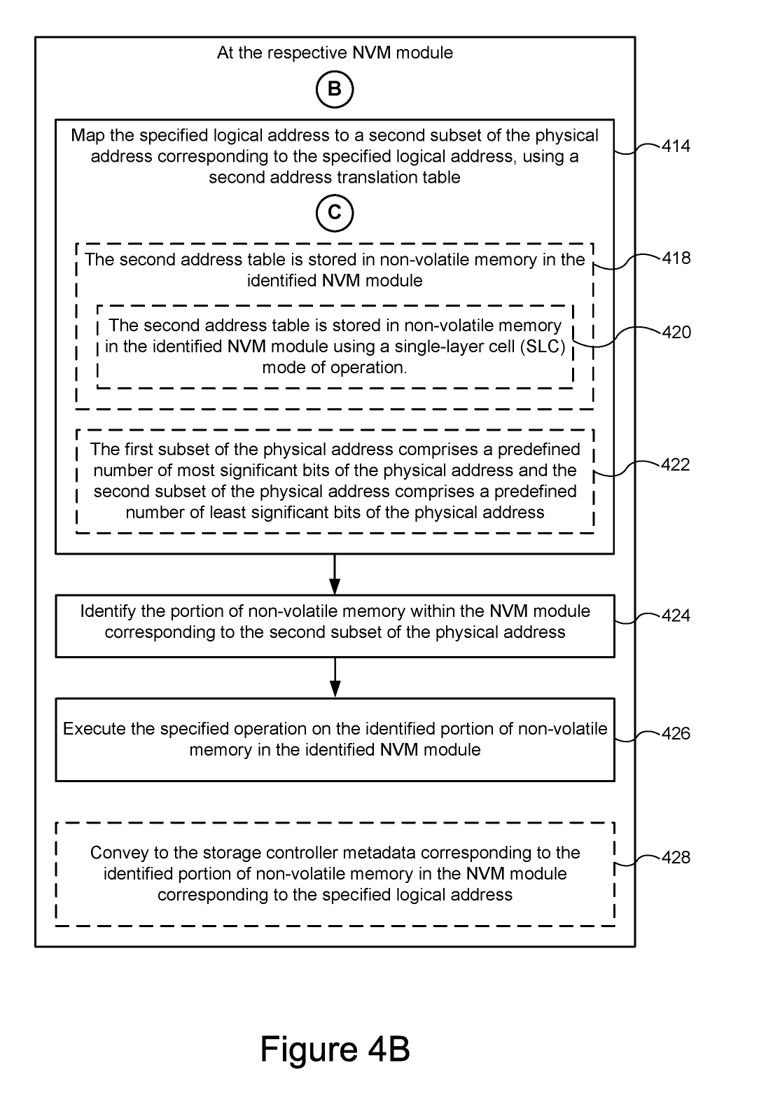

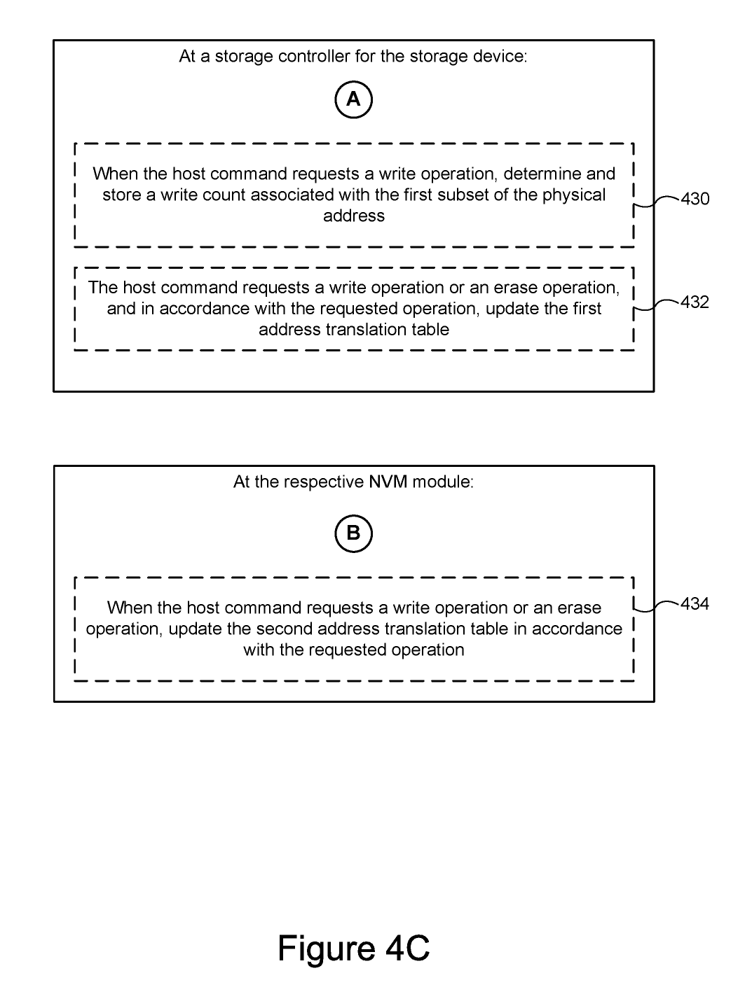

Each of the above identified elements may be stored in one or more of the previously mentioned storage devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 206 may store a subset of the modules and data structures identified above. Furthermore, memory 206 may store additional modules and data structures not described above. In some embodiments, the programs, modules, and data structures stored in memory 206, or the computer readable storage medium of memory 206, include instructions for implementing respective operations in the methods described below with reference to FIGS. 4A-4C and 5.

Although FIG. 2A shows NVM module 160 in accordance with some embodiments, FIG. 2A is intended more as a functional description of the various features which may be present in an NVM module than as a structural schematic of the embodiments described herein. In practice, and as recognized by those of ordinary skill in the art, items shown separately could be combined and some items could be separated.

FIG. 2B is a block diagram illustrating an exemplary management module 121 in accordance with some embodiments. Management module 121 typically includes: one or more processing units 252 (also sometimes called CPUs, processors, hardware processors, microprocessors or microcontrollers) for executing modules, programs and/or instructions stored in memory 256 and thereby performing processing operations; memory 256; and one or more communication buses 258 for interconnecting these components. Communication buses 258, optionally, include circuitry (sometimes called a chipset) that interconnects and controls communications between system components. Management module 121 is coupled to input buffer 135, output buffer 136, error control module 132, and storage medium interface 138 by communication buses 258. Memory 256 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 256, optionally, includes one or more storage devices remotely located from the CPU(s) 252. Memory 256, or alternatively the non-volatile memory device(s) within memory 256, comprises a non-transitory computer readable storage medium. In some embodiments, memory 256, or the non-transitory computer readable storage medium of memory 256, stores the following programs, modules, and data structures, or a subset or superset thereof:
command module 246 (sometimes called an interface module), to receive or access a host command specifying an operation to be performed and a logical address corresponding to a portion of non-volatile memory within the storage device;
data read module 230 for reading data from storage medium 161 (FIG. 1B), for example flash memory (e.g., one or more flash memory devices, such as NVM devices 140, 142);
data write module 232 for writing data to storage medium 161;
data erase module 234 for erasing data from storage medium 161;
global garbage collection module 236 used for selecting a memory module of storage medium 161, using status information locally stored in the storage device controller for individual NVM modules or individual non-volatile memory devices in the storage device, and sending a garbage collection command to the selected NVM module, instructing the selected memory module to perform a garbage collection operation;
storage medium status information 260, including status information for respective memory modules or memory die in storage device 120, as described in more detail below; status information 260 is typically stored in one or more tables or other data structures (e.g., a garbage collection and wear leveling (GC &WL) table 262) in memory 256;
map module 264, to map a specified logical address to a first subset of a physical address corresponding to the specified logical address, using first address translation table 170;
a forwarding module 266 to forward a command, corresponding to a host command, to an NVM module of the plurality of NVM modules identified in accordance with the first subset of the physical address, produced by map module 264; and
first address translation table 170 for associating logical addresses with first subsets of respective physical addresses (e.g., the first 31 bits of 37-bit physical addresses) for respective portions of storage medium 161, FIG. 1B (e.g., a distinct flash memory device, die, block zone, block, word line, or word line zone of storage medium 161); in some embodiments, for logical addresses corresponding to valid data stored in the storage medium 161, first address translation table 170 stores a subset of the corresponding physical memory address (e.g., the first 31 bits of a 37-bit physical address).

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 256 may store a subset of the modules and data structures identified above. Furthermore, memory 256 may store additional modules and data structures not described above. In some embodiments, the programs, modules, and data structures stored in memory 256, or the non-transitory computer readable storage medium of memory 256, provide instructions for implementing any of the methods described below with reference to FIGS. 4A-4C and 5.

Although FIG. 2B shows a management module 121, FIG. 2B is intended more as functional description of the various features which may be present in a management module than as a structural schematic of the embodiments described herein. In practice, and as recognized by those of ordinary skill in the art, the programs, modules, and data structures shown separately could be combined and some programs, modules, and data structures could be separated.

Referring to FIG. 2C, in some embodiments, global garbage collection information table 262 (see FIG. 2B) includes a set of records 270-1, 270-2, etc., where each record 270 includes status information for a particular non-volatile memory device 140 or 142 (sometimes called a “chip”) in a respective NVM module 160. In some embodiments, the status information stored in table 262 for a particular non-volatile memory device includes identifying information 272 identifying the memory device; valid page information 274, indicating the number of pages containing valid data in one or more blocks of the identified memory device; over-provisioning or empty block information 276, indicating the number of unused blocks, sometimes called empty blocks, in the identified memory device; and, optionally, health information or wear-leveling information 278 for the identified memory device. In some embodiments, over-provisioning or empty block information 276 indicates the number of erased blocks in the identified memory device, as opposed to the number of unused blocks, some of which might not be erased.

In some embodiments, valid page information 274 in a respective record 270 indicates the number of valid pages in a block of the identified memory device that has not been erased or garbage collected since the last time data was written to it, and that has the smallest amount of valid data of all the blocks in the identified memory device. In some other embodiments, valid page information 274 indicates the number of valid pages in each of two or more blocks of the identified memory device that have not been erased or garbage collected since the last time data was written to them. For example, in some such embodiments, valid page information 274 indicates the number of valid pages in blocks (of the identified memory device) having the 5, 25, 50, 75 and 95 percentile amounts of pages with valid data. In another example, in some such embodiments, page information 274 indicates the number of valid pages in two or more blocks (of the identified memory device), such as the block with the smallest number of valid pages, and the block with the median number of valid pages, with respect to the set of blocks in the identified memory device. In some embodiments, valid page information 274 includes a count of a number of blocks that have not been erased or garbage collected since the last time data was written to them and that have less than a threshold number valid pages.

In some embodiments, over-provisioning or empty block information 276 in a respective record 270 indicates the number of unused blocks in the identified memory device, which are blocks having no valid data. However, in some embodiments, over-provisioning or empty block information 276 indicates the number of erased blocks in the identified memory device. Erased blocks are ready to store data, while unused blocks (sometimes called empty blocks) that have not yet been erased still need to be erased before data can be stored in them.

In some embodiments, health information or wear-leveling information 278 in a respective record 270 indicates the value of a health or wear-leveling metric, such as a value between 1 and 10, or other predefined range, for the identified memory device. In some such embodiments, health information or wear-leveling information 278 for the identified memory device, includes an “age” metric (e.g., based on number of program erase cycles, and/or other usage or wear-related metric) or performance metric (e.g., a value corresponding to a bit error rate determined when reading data) for one or more blocks of the identified memory device.

For example, in some such embodiments, health information or wear-leveling information 278 in a respective record 270 indicates the respective age or performance metric for blocks in the identified memory device having the 5, 25, 50, 75 and 95 percentile values of that metric. In another example, in some such embodiments, health information or wear-leveling information 278 in a respective record 270 indicates the respective age and/or performance metric of two or more blocks of the identified memory device, such as the block with the lowest age, and the block with the median age, with respect to the set of blocks in the identified memory device. In some embodiments, health information or wear-leveling information 278 in a respective record 270 includes, for each of N values of the age or performance metric, a count of the number of blocks that have that age or performance metric value.

In some embodiments, the records 270 in global garbage collection information table 262 do not include health information or wear-leveling information 278. Instead, in such embodiments, health information or wear-leveling information is stored and managed by the NVM controllers 130 of the NVM modules 160.

In some embodiments, the records 270 in global garbage collection information table 262 do not include valid page information 274. Instead, in such embodiments, valid page information is stored and managed by the NVM controllers 130 of the NVM modules 160.

Referring to FIG. 2D, in some embodiments, local garbage collection information table 220 (see FIG. 2A) includes a set of records 280-1, 280-2, etc., where each record 280 includes status information for a particular block in the non-volatile memory devices in the NVM module 160 that include local garbage collection information table 220. In some embodiments, the status information stored in a record 280 of table 220 for a particular block of a non-volatile memory device includes identifying information 282 identifying the block of the memory device corresponding to the record 280; valid page information 284, indicating the number of pages containing valid data in the identified block; and health information or wear-leveling information 286 for the identified block. See discussion of health information or wear-leveling information 278, with reference to FIG. 2C, for examples of health information or wear-leveling information for a respective block (e.g., an age metric and/or performance metric).

It is noted that blocks have zero valid pages are unused blocks. In some embodiments, when a respective NVM module 160 (or its NVM controller 130) provides updated status information to the storage device controller, counts of blocks having zero valid pages are provided to the storage device controller, stores that information as over-provisioning or empty block information 276 in global garbage collection information table 262.

In some embodiments, records 280 of table 220 do not include identifying information 282, because the block corresponding to each record 280 can be unambiguously determined from the position of the record 280 in table 220. In a simplified example, if the memory devices in a respective NVM module 160 have a predefined order, each memory device has 100 blocks, and each record has an offset, then for any given record 280, the corresponding memory device and block are identified by applying appropriate mathematical functions (e.g., dividing the record's offset by 100 or by the length of each record 280, to identify the memory device, and by using the remainder obtained when dividing the record's offset by 100 or by the length of each record 280, to identify the block within the identified memory device).

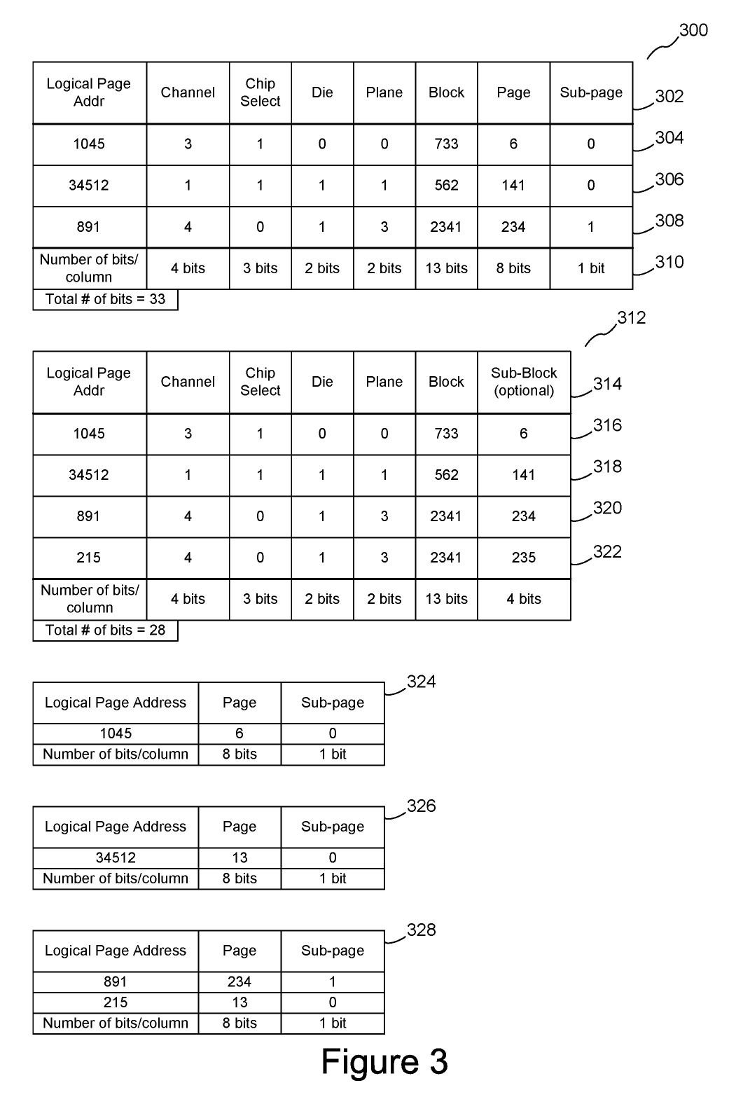

FIG. 3 illustrates various logical to physical memory address translation tables, in accordance with some embodiments.

Table 300 illustrates an exemplary logical-to-physical address translation scheme that requires 33 bits per physical address (as counted in row 310). In some embodiments, intermediate structures exist between the ones in table 300 (e.g., sub-block, sub-channel), requiring additional physical addressing bits to identify. In some embodiments, a computer system comprising a storage device (e.g., data storage system 100, FIGS. 1A-1C), uses a 32-bit addressing bus. In such embodiments, the logical-to-physical address translation scheme represented in table 300 either requires 2 accesses per operation (e.g., read, write or erase) to logical-to-physical address table 300, or requires upgrading the addressing bus of the system to a 64-bit bus (or any sized bus with greater than 32 bits). Either one of these approaches is inefficient and wasteful of computing resources.

Tables 312, 324, 326 and 328, on the other hand, are examples of logical-to-physical addressing tables corresponding to the present application. For example, table 312 is a logical-to-physical address translation table comprising partial physical addresses (e.g., in rows 316, 318, 320 and 322), each of which corresponds to a logical address and identifies a coarse memory portion within the plurality of NVM modules. In some embodiments, each partial physical address in table 312 can be referred to as a first subset of a physical address, and in some embodiments this first subset of a physical address comprises a predetermined number of most significant bits of the corresponding physical address. For example, table 312 is first address translation table 170 of storage device controller 128 (FIGS. 1B-1C).

Tables 312, 324, 326 and 328 illustrate the scalable and distributed nature of the addressing scheme of this application. A partial physical address in table 312 requires between 24 and 28 bits of representation, allowing for 4-8 bits of additional addressing information on a conventional 32-bit memory addressing bus. The scalable nature of this addressing scheme is best described with respect to tables 324, 326 and 328, each of which reside, in this example, on distinct NVM modules (e.g., NVM modules 160, FIGS. 1A-1B).

For example, in address translation table 312 (e.g., first address translation table 170, FIG. 1B), logical address 1045 (in row 316) corresponds to a partial physical address (e.g., first subset of a physical address) corresponding to an NVM module on memory channel 3 (sometimes herein called channel 3), chip select 1, die 0, plane 0, block 733 and optionally sub-block 6. Using this partial physical address information, the storage device controller sends information regarding an operation to be performed, along with the logical address and corresponding first subset of a physical address to the NVM module on memory channel 3. In some embodiments, the storage device controller writes this partial physical address, in accordance with the operation to be performed (e.g., for a write or erase). This NVM module then refers to another logical-to-physical address translation table 324 (e.g., second address translation table 190, FIG. 1B), and either reads or writes an entry corresponding to logical address 1045, along with another partial physical address, also referred to as a second subset of a physical address. In some embodiments, table 324 (e.g., the second address translation table) is stored at the identified block in table 312, or another identified location within the NVM module.

In some embodiments, the memory operation is performed, and then the second address translation table is updated and/or the first address translation table is updated. For example, for an erase operation, the physical address of a page to be erased is determined (e.g., as for a read operation), the erase operation is performed, the second address table is updated to reflect the erased page, then the first address table is updated to reflect the erased page.

This tiered addressing scheme is not limited to two tiers of addressing. As storage systems and storage devices increase in capacity, the need for intermediate modules or structures within storage devices will result in increasingly longer physical addresses. In some embodiments, additional tiers of addressing will reside in these intermediate modules or structures.

FIGS. 4A-4C illustrate a flowchart representation of method 400 of operating a storage device having a plurality of NVM modules, in accordance with some embodiments. At least in some implementations, method 400 is performed by a storage device (e.g., storage device 120, FIG. 1A) or one or more components of the storage device (e.g., NVM controllers 130 and/or storage device controller 128, FIG. 1B). In some embodiments, method 400 is governed by instructions that are stored in a non-transitory computer readable storage medium and that are executed by one or more processors of a device, such as the one or more NVM controllers 130 of NVM modules 160, as shown in FIGS. 1B and 2A.

The method includes receiving (402), or alternatively accessing (e.g., from a command queue), a host command specifying an operation (e.g., reading, writing, erasing) to be performed and a logical address corresponding to a portion of non-volatile memory within the storage device. For example, a storage device (e.g., storage device 120, FIG. 1A) receives or accesses a host command to write to a block of memory (e.g., a block of memory on one of NVM devices 140, 142). In some embodiments, the portion of non-volatile memory is a block, sometimes called an erase block. In some embodiments, the portion of non-volatile memory is a portion of an erase block, such as a page.

In some embodiments, the storage device comprises (404) one or more three-dimensional (3D) memory devices and circuitry associated with operation of memory elements in the one or more 3D memory devices. In some embodiments, the circuitry and one or more memory elements in a respective 3D memory device (406), of the one or more 3D memory devices, are on the same substrate. In some embodiments, the storage device comprises (408) one or more flash memory devices.

The method includes, at a storage controller for the storage device, mapping (410) the specified logical address to a first subset of a physical address corresponding to the specified logical address, using a first address translation table. For example, referring to FIG. 3, table 312 shows a logical-to-physical address translation table that resides in storage device controller 128, FIG. 1C (e.g., first address translation table 170). In this example in FIG. 3, the host command is to write to a page (or sub-page) having a logical address of 1045. Row 316 of table 312 shows a logical address 1045, that maps to a partial physical address (or first subset of a physical address), indicating memory channel 3, chip select 1, die 0, plane 0, block 733, and optionally sub-block 6.

The method includes, at a storage controller for the storage device, identifying (412) an NVM module of the plurality of NVM modules, in accordance with the host command. For example, the storage controller (e.g., storage device controller 128, FIG. 1B) of the storage device receives a host command to write to a block of memory, identifies an NVM module (e.g., NVM module 160-1, FIG. 1B), for performing the write operation. For example, the host command is to write data to a block of NVM memory on NVM device 140-2 (FIG. 1B), residing within NVM module 160-1 (FIG. 1B). Referring to the example in FIG. 3, for the logical address 1045, table 312 indicates that this logical address maps to a partial physical address residing on memory channel 3. In some embodiments, the channel bits of the partial physical address indicate the NVM module where the portion of memory resides (e.g., the page or sub-page that logical address 1045 maps to, is on the NVM module on memory channel 3, in the example in table 312 of FIG. 3).

The method includes, at the identified NVM module, mapping (414) the specified logical address to a second subset of the physical address corresponding to the specified logical address, using a second address translation table. For example, looking again at FIG. 3, table 324 is a segment of a logical-to-physical address table managed by an NVM module on memory channel 3. In this example, the NVM module on memory channel 3 receives the host command, logical address and first subset of the physical address from the storage controller (e.g., writing to a page associated with logical address 1045, having a first subset of a physical address identifying channel 3, chip select 1, die 0, plane 0, block 733, and optionally sub-block 6). In this example, the NVM module on channel 3 maps logical address 1045 to a second subset of the physical address (e.g., page 6 and sub-page 0).

In some embodiments, the second address table is pre-loaded (416) into cache memory in the NVM module. For example, the second address translation table 226 (FIG. 2A) is stored in volatile memory (e.g., volatile data 228, FIG. 2A), or byte-addressable cache memory for fast access and updating during normal operation of the NVM module and/or storage device.

In some embodiments, the second address table is stored (418) in non-volatile memory in the identified NVM module, and in some embodiments, the second address table is stored (420) in non-volatile memory in the identified NVM module using a single-layer cell (SLC) mode of operation.

In some embodiments, the first subset of the physical address comprises (422) a predefined number of most significant bits of the physical address and the second subset of the physical address comprises a predefined number of least significant bits of the physical address. For example, as can be seen in FIG. 3, for logical address 891, row 320 of table 312 indicates that the portion of the corresponding physical address comprises 28 bits, and in this case, the first 28 bits of the physical address. In this example, table 328 in FIG. 3, comprises the rest of the physical address corresponding to logical address 891, consisting of the last 9 bits of the physical address. It should be noted that in some embodiments, a respective physical address is partitioned into more than two portions or subsets. For example, as the size of storage device 120 (FIG. 1A-1B) increases, one or more intermediate structures is introduced between the storage device controller 128 and NVM modules 160, requiring additional addressing bits and in some embodiments, additional tiers of addressing tables.

The method includes, at the identified NVM module, identifying (424) the portion of non-volatile memory within the NVM module corresponding to the specified logical address. For example, a predefined portion of the physical address is decoded to identify, within the NVM module, a particular flash memory die, a particular erase block within the flash memory die, and a particular page within the erase block. Referring back to the exemplary tables in FIG. 3, for logical address 34512, in table 326, page 13 (or sub-page 0) is identified, at block 562 of plane 1, of die 1, of chip select 1 of the NVM module on channel 1 of the storage medium (as can be seen from row 318 of table 312).

The method includes, at the identified NVM module, executing (426) the specified operation on the identified portion of non-volatile memory in the identified NVM module. For example, when the host command is a read command, executing the specified operation on the identified portion of non-volatile memory in the identified NVM module includes reading data from the identified portion of non-volatile memory in the identified NVM module. In another example, a write operation of the host command is performed on page 13 of block 562 of the previous example in FIG. 3.

In some embodiments, the method further includes, at the identified NVM module, conveying (428) to the storage controller metadata corresponding to the identified portion of non-volatile memory in the NVM module corresponding to the specified logical address. In some embodiments, the NVM module and/or the storage controller store additional information regarding respective portions of memory in the storage device. For example, this additional information (e.g., metadata) comprises health or reliability information, described above with respect to FIGS. 1A-2B.

In some embodiments, the method further includes, at a storage controller for the storage device, in accordance with a determination that the host command requests a write operation, determining (430) and storing a write count associated with the first subset of the physical address. For example, the write count associated with the first subset of the physical address is incremented by one. In some embodiments, the write count corresponds to the number of physical addresses corresponding to the first subset of a physical address, to which data has been written. For example, looking at rows 320 and 322 of table 312 in FIG. 3, the number of logical addresses written to the same first subset of a physical address is 2, therefore the next time a logical address is written to this same first subset of a physical address, the write count is increased to 3. In some embodiments, there is a limit to the number of logical addresses that can be written to the same first subset of a physical address (e.g., 32). If a host command would result in the write count for a particular first subset of a physical address being greater than the limit (e.g., 32), then a next partial physical address (i.e., another first subset of another physical address) is generated and the data for the additional logical addresses is sent to the NVM module with the next partial physical address and a write count for the next partial physical address is determined and stored by the storage controller.

In some embodiments, when the host command that is received or accessed is a write command that requests a write operation or an erase command that requests an erase operation, the method further includes, at a storage controller for the storage device, updating (432) the first address translation table in accordance with the requested operation. In addition, the method includes, at the respective (identified) NVM module, updating (434) the second address translation table in accordance with the requested operation. For example, while a read operation accesses data after looking up a physical address, write or erase operations change logical to physical address translation tables as data is being written, overwritten or erased from physical memory.

Referring back to FIG. 3, looking at table 312 again, for example, the host command comprises a request to write a page of data corresponding to a logical address of 215. In this example, before row 322 exists in table 312, the storage controller looks for an open block with enough available space (e.g., pages) to write the data in the host command. In this example, the block corresponding to logical address 891 (i.e., the partial physical address in row 320), is open and has available space. The storage controller is aware that there is enough space in this block because it has maintained a write counter for this block and can determine that empty or available pages exist. In this example, the storage controller updates table 312 by creating an entry for the write operation corresponding to logical address 215.

In this example, the storage controller sends the host command, the logical address and the partial physical address written to row 322 of table 312 (i.e. a first subset of a physical address), to the NVM module on channel 4. The NVM module on channel 4 uses the received first subset of a physical address to determine the open block that the storage controller has identified for performing this write operation. In some embodiments, the NVM module has greater knowledge of bad sectors (e.g., through health and reliability information or metadata), than the storage controller, and determines that the block identified by the storage controller for the write operation has corrupt pages and therefore cannot store the data from the host command after all. In some embodiments, the NVM module selects another location to write the data to within the storage space of the NVM module, updates the second address table accordingly, and conveys the updated address information to the storage controller to update the first address table accordingly.

In some embodiments, after executing the operation of a host command, the storage device sends a confirmation message back to the host computer (e.g., computer system 110, FIGS. 1A-1C).

### Garbage Collection

As noted above, data is written to a non-volatile storage medium in pages, but the storage medium is erased in blocks. As a result, pages in the storage medium may contain invalid (e.g., stale) data, but those pages cannot be overwritten until the whole block containing those pages is erased. In order to write to the pages with invalid data, the pages (if any) with valid data in that block are read and re-written to a new block and the old block is erased (or put on a queue for erasing). This process is called garbage collection (also sometimes called data recycling). After garbage collection, the new block contains the pages with valid data and may have free pages that are available for new data to be written, and the old block can be erased so as to be available for new data to be written. Since flash memory can only be programmed and erased a limited number of times, the efficiency of the algorithm used to pick the next block(s) to re-write and erase has a significant impact on the lifetime and reliability of flash-based storage systems.

Write amplification is a phenomenon where the actual amount of physical data written to a storage medium (e.g., NVM devices 140, 142 in storage device 120) is a multiple of the logical amount of data written by a host (e.g., computer system 110, sometimes called a host) to the storage medium. Since a block of storage medium must be erased before it can be re-written, the garbage collection process to perform these operations results in re-writing data one or more times. This multiplying effect increases the number of writes required over the life of a storage medium, which shortens the time it can reliably operate. The formula to calculate the write amplification of a storage system is given by equation:

$$\frac{amount of data written to a storage medium}{amount of data written by a host}$$

One of the goals of any flash memory based data storage system architecture is to reduce write amplification as much as possible so that available endurance is used to meet storage medium reliability and warranty specifications. Higher system endurance also results in lower cost as the storage system may need less over-provisioning. By reducing write amplification, the endurance of the storage medium is increased and the overall cost of the storage system is decreased. Generally, garbage collection is performed on blocks with the fewest number of valid pages for best performance and best write amplification.

In some embodiments, data reclamation garbage collection events correspond to occurrences of one or more host data write operations in accordance with a target reclamation recycle ratio (also sometimes called a target reclamation to host write ratio). A target recycle ratio is determined to maintain a spare block pool of unused or empty blocks (i.e., blocks having no valid data) at a target spare block pool size, and to maintain relatively uniform and even device performance. In some embodiments, the recycle ratio is expressed as:

$$\begin{matrix}recycle ratio = \frac{amount of data written for garbage collection}{amount of data written by a host} \\ = write amplification - 1\end{matrix}$$

In some embodiments, the current recycle ratio is periodically checked against a target recycle ratio, and the target recycle ratio is adjusted accordingly. Furthermore, each time a write operation completes, a corresponding number of garbage collection operations are triggered, based on the target recycle ratio. For example, if the target recycle ratio is equal to 2, and the size of each data write operation is “N” pages (e.g., 8 pages, each having a predefined page size, such as 32 KB), each time a host data write operation is completed (306), two garbage collection operations (314-318) on “N” pages are triggered.

FIG. 5 illustrates a flowchart of a method 500 of managing garbage collection in a storage device having a storage controller (e.g., storage device controller 128, FIG. 1B) as well as a plurality of NVM modules (e.g., NVM modules 160, FIG. 1B) that each include two or more non-volatile memory devices (e.g., NVM devices 140 or 142, FIGS. 1A, 2A) and a module controller (e.g., NVM controller 130, FIGS. 1A, 2A) for controlling operations performed within the respective NVM module. Method 500 includes operations performed by a storage controller (e.g., storage device controller 128, FIG. 1B, or management module 121 of storage device controller 128, as shown in FIG. 2B), and operations performed by at least one respective NVM module or NVM controller (e.g., any NVM module 160 shown in FIG. 1B, or NVM controller 130 shown in FIG. 2A).

In some embodiments, method 500 begins when a trigger condition is detected (502) by the storage controller. For example, when the size of a spare block pool of unused (or empty or erased) storage blocks fails to satisfy predefined criteria (e.g., when the number of blocks in the spare block pool falls below a threshold level, or when a predicted or projected number of blocks in the spare block pool falls below a threshold level), the trigger condition is detected. In another example, as explained above, a predefined number of garbage collection operations are initiated in response to or in conjunction with each host write operation. In another example, the trigger condition is detected on a periodic basis, such as when a timer expires.

In some embodiments, the storage controller, using status information locally stored in the storage controller for individual NVM modules or individual non-volatile memory devices in the storage device, selects (503) an NVM module, and sends (512) a garbage collection command to the selected NVM module. As described in more detail below, in some embodiments selecting the NVM module includes identifying an NVM module or non-volatile memory device (e.g., by performing one or more of operations 504-508), where the selected NVM module is the identified NVM module or the NVM module that includes the identified non-volatile memory device. In some embodiments, the status information locally stored in the storage controller includes information concerning quantities of unused memory portions in each NVM module or non-volatile memory device in the storage device, the unused memory portions comprising memory portions having no valid data.

In some embodiments, method 500 includes determining (510) one or more parameters to include in the garbage collection command to be sent to the selected NVM module. For example, in some embodiments, the garbage collection command includes device identifying information that identifies a particular non-volatile memory device on which to perform garbage collection. In some such embodiments, based on status information (e.g., in global garbage collection information table 262, described above with reference to FIG. 2C) locally stored in the storage controller, the storage controller may select a non-volatile memory device for garbage collection, and include a parameter in the garbage collection command that indicates the selected non-volatile memory device. As discussed in more detail below, in some embodiments the status information used by the storage controller to select a non-volatile memory device for garbage collection includes information indicating the number of unused or empty blocks in each non-volatile memory device in the storage device. Alternatively, in some embodiments the status information used by the storage controller to select a non-volatile memory device for garbage collection includes information indicating the number of unused or empty blocks in two or more non-volatile memory devices in the storage device (e.g., in one or more non-volatile memory devices in each NVM module in the storage device).

Furthermore, in some embodiments, the status information used by the storage controller to select a non-volatile memory device for garbage collection comprises information indicating the amount of valid data in one or more blocks of each non-volatile memory device in the storage device. Alternatively, in some embodiments the status information used by the storage controller to select a non-volatile memory device for garbage collection comprises information indicating the amount of valid data in respective blocks of two or more non-volatile memory devices in the storage device.

In some embodiments, the garbage collection command includes a quantity parameter indicating a number of garbage collection operations that the selected NVM module is to perform, or a quantity of memory portions (e.g., pages) to garbage collect, in response to the garbage collection command. In some embodiment, the storage controller determines the quantity parameter to include in the garbage collection command based on status information (e.g., in global garbage collection information table 262, described above with reference to FIG. 2C) locally stored in the storage controller. For example, in some embodiments, the quantity parameter is determined based on locally stored status information indicating the number of unused or empty blocks in one or more non-volatile memory devices in the NVM module to which the garbage collection command will be sent, and/or locally stored status information indicating the amount of valid data in one or more blocks of one or more non-volatile memory devices in the NVM module to which the garbage collection command will be sent.

In some embodiments, the garbage collection command specifies one or more valid data parameters indicating valid data criteria to be applied by the selected NVM module so as to select one or more memory portions on which to perform garbage collection.

Method 500 further includes, at the selected NVM module, receiving (520) the garbage collection command sent by the storage controller to the selected NVM module. In accordance with the received garbage collection command, and in accordance with status information locally stored in the selected NVM module, the selected NVM module selects or identifies (522) a memory portion of non-volatile memory in the selected NVM module and initiates (526) garbage collection of valid data in the selected memory portion. Performing garbage collection of valid data in the selected memory portion includes copying valid data in the selected memory portion to a target memory portion in the selected NVM module, which changes the physical addresses at which the copied valid data is stored. Typically, performing the garbage collection operation also includes updating one or more address translation tables (e.g., first address translation table 170, FIG. 2B, and second address translation table 226, FIG. 2A) to indicate that the selected memory portion no longer stores any valid data, and updating one or more address translation tables (e.g., second address translation table 226, FIG. 2A) to indicate the new physical address(es) of the valid data that was copied to the target memory portion. Optionally, performing the garbage collection operation also includes updating other internal data structures (e.g., garbage collection and wear leveling information table 222) with new or updated status information.

In some embodiments, upon completion of a garbage collection operation (526) by the selected NVM module, and all internally stored information (e.g., address translation information, and optionally status information) corresponding to the garbage collection operation has been updated, a completion status is sent back to the storage controller by issuing an interrupt, such as a “completion interrupt.” When the storage controller receives or processes the interrupt, it knows that the requested garbage collection operation has been completed, and can then proceed accordingly (e.g., by sending a request to the selected NVM module for updated status information, or sending one or more additional garbage collection commands to the same or another NVM module.)

In some embodiments, or in some circumstances, the selected NVM module repeats (528) operations 522-526 a number of times, so as to perform garbage collection on two or more memory portions identified by each iteration of operation 522, in accordance with one or more parameters in the received garbage collection command.

It is noted that the status information locally stored in the selected NVM module includes status information with respect to smaller memory portions than the status information locally stored in the storage controller. For example, in some embodiments, the status information locally stored in the storage controller is status information for individual memory devices, while the status information locally stored in the selected NVM module comprises status information for each block of each memory device in the selected NVM module.

In some embodiments, the status information locally stored in the storage controller includes information concerning quantities of unused memory portions in each NVM module or non-volatile memory device in the storage device, where the unused memory portions are memory portions having no valid data. In some such embodiments, identifying an NVM module or non-volatile memory device (503) includes comparing information regarding quantities of unused memory portions in each NVM module of two or more NVM modules of the plurality of NVM modules with one or more predefined thresholds, and identifying the NVM module in accordance with an outcome of the comparing. Unused memory portions are sometimes called empty memory portions, as they store no valid data. In some embodiments, when a garbage collection command is sent to an NVM module, the NVM module performs garbage collection in all memory devices in the module that have at least one block that meets predefined garbage collection criteria. In some embodiments, the garbage collection command sent to the NVM module specifies a number of blocks to be garbage collected, and leaves it up to the NVM module to determine which blocks in the NVM module (i.e., in memory devices in the NVM module) to garbage collect.

In some embodiments, the status information locally stored in the storage controller includes information concerning quantities of unused memory portions in each NVM module or non-volatile memory device in the storage device, where the unused memory portions are memory portions having no valid data. In some such embodiments, identifying an NVM module or non-volatile memory device includes comparing information regarding quantities of unused memory portions in each memory device of two or more non-volatile memory devices in the storage device with one or more predefined unused memory thresholds, and identifying a non-volatile memory device in accordance with an outcome of the comparison.

In some embodiments, the garbage collection command sent to the selected NVM module includes one or more memory portion selection parameters for constraining the selection of a memory portion (for garbage collection) by the selected NVM module. Furthermore, in some embodiments, the status information locally stored in the storage controller includes information concerning quantities of valid data in at least some memory portions in each non-volatile memory device in the storage device, or information concerning quantities of valid data in at least some memory portions in each NVM module of the plurality of NVM modules.

In some embodiments, the one or more memory portion selection parameters in the garbage collection command sent to the selected NVM module includes a valid data parameter, and the selected NVM module, when selecting a memory portion of non-volatile memory in the selected module, selects a memory portion consistent with the valid data parameter. For example, in some embodiments, the valid data parameter indicates a number of valid pages, and the selected NVM module selects a block having no more valid pages than the number of valid pages indicated by the valid data parameter. In some such embodiments, the valid data parameter is a threshold value. Alternatively, the valid data parameter in the garbage collection command is a percentile parameter based on valid data quantity information in the status information stored in the storage controller, where the percentile parameter indicates to the selected NVM module to select a block in the NVM module whose quantity of valid pages falls in the lowest P percentile with respect to valid pages, where P is (or is indicated by) the percentile parameter.

In some embodiments, the garbage collection command includes one or more target memory portion selection parameters for constraining selection of the target memory portion by the selected NVM module. In some such embodiments, the one or more target memory portion selection parameters include an age metric or health metric, and the selected NVM module selects (524) the target memory portion of non-volatile memory in the selected NVM module in accordance with the age metric or health metric in the garbage collection command. Providing an age metric or health metric in the garbage collection command enables the storage controller to control wear-leveling within the NVM module to which the garbage collection command is sent.

In some embodiments, the status information locally stored in the selected NVM module includes valid data quantity information, the valid data quantity information including a respective valid data parameter for each memory portion of a plurality of memory portions in each memory device in the selected NVM module, where the respective valid data parameter for a respective memory portion in the selected NVM module indicates a quantity of valid data in the respective memory portion in the selected NVM module. In such embodiments, the method includes, at the selected NVM module, selecting a memory portion as the selected memory portion in accordance with the valid data quantity information locally stored in the selected NVM module. It is noted that typically, but not necessarily, each memory portion is a block in a flash memory device. Alternatively, the valid data quantity information locally stored in the NVM module is organized by superblocks, each having two or more blocks, and the selection is a selection of a superblock on which a garbage collection operation is to be performed. In embodiments that perform garbage collection on superblocks, health or wear information is also organized by superblocks, and target memory portion selection (524) comprises selection of a target superblock, based on health and/or wear information stored in the NVM module.

In some embodiments, the status information locally stored in the selected NVM module includes age or health information, the age or health information including an age metric or health metric for each memory portion of a plurality of memory portions in each memory device in the selected NVM module, where the respective age metric or health metric for a respective memory portion in the selected NVM module indicates a measurement of operational age or health of the respective memory portion in the selected NVM module. In such embodiments, the method includes, at the selected NVM module, selecting a memory portion as the target memory portion in accordance with the age or health information locally stored in the selected NVM module.

In some embodiments, method 500 includes, at the storage controller, updating the status information locally stored in the storage controller with status information received from a respective NVM module of the plurality of NVM modules. In some such embodiments, method 500 includes, at the storage controller, sending a status update request to a respective NVM module of the plurality of NVM modules; and, at the respective NVM module, in response to receiving the status update request, sending to the storage controller status information based on status information locally stored in the respective NVM module. Further, in some such embodiments, the storage controller then updates its locally stored status information with the status information sent to the storage controller by the respective NVM module in response to the status update request.

In some embodiments, method 500 further includes a distributed, or two-level, address translation of a logical address. In particular, in some such embodiments, method 500 includes receiving or accessing a host command that specifies an operation to be performed and a logical address corresponding to a portion of non-volatile memory within the storage device. In response to receiving or accessing the host command, the storage controller for the storage device maps the specified logical address to a partial physical address, which is first subset of a physical address corresponding to the specified logical address, using a first address translation table (e.g., first address translation table 170, FIG. 2B), and identifies an NVM module of the plurality of NVM modules, in accordance with the first subset of the physical address. The partial physical address identifies a “coarse” memory portion that is located in the identified NVM module.

Typically, a memory operation command corresponding to the host command is sent by the storage controller to the identified NVM module, and that memory operation command includes the first subset of a physical address corresponding to the specified logical address (or, alternatively, it includes the portion of the partial physical address other than the portion that identifies the NVM module to which the memory operation command is sent), and furthermore typically includes the logical address as well. The identified NVM module maps the specified logical address to a second subset of the physical address corresponding to the specified logical address, using a second address translation table (e.g., second address translation table 226, FIG. 2A), identifies the portion of non-volatile memory (sometimes called a fine memory portion, which is a portion or subset of the aforementioned coarse memory portion) within the identified NVM module corresponding to the second subset of the physical address, and executes the specified memory operation (specified by the memory operation command) on the identified portion of non-volatile memory in the identified NVM module. Stated more succinctly, in response to a host command that specifies an operation to be performed and a logical address corresponding to a portion of non-volatile memory within the storage device, the storage controller identifies a coarse memory portion, corresponding to or located within an NVM module, and the NVM module identifies a fine memory portion within the NVM module (and within the coarse memory portion) on which a corresponding memory operation is performed.

In some embodiments, method 500 includes a control loop (e.g., operations 504-512) performed by the storage controller, which attempts to ensure that every memory device in the storage device has at least a predefined number of unused blocks, thereby ensuring that every memory device in the storage device has at least the predefined number of blocks ready to store new or recycled data. However, in some embodiments, garbage collection is initiated by the storage controller only for memory devices that satisfy both empty block criteria and valid data criteria.

In some embodiments, selecting or identifying an NVM module to send a garbage collection command includes processing information for each NVM module (504) or each non-volatile memory device in the storage device, including repeating a sequence of operations (e.g., operations 504-512) with respect to each NVM module or each non-volatile memory device in the storage device. At operation 504, a next non-volatile memory device is selected or identified. For example, operation 504, over multiple iterations of that operation, selects every non-volatile memory device in the storage device. As descried above with respect to FIG. 2C, in some such embodiments, the storage module locally stores information concerning the number of unused memory blocks in each non-volatile memory device of the storage device. If the currently identified memory device fails to satisfy predefined low overprovisioning criteria (506—No), for example because the number of unused blocks in the memory device is greater than a predefined threshold, a next non-volatile memory device is identified (at 504). However, in some embodiments, if the currently identified memory device satisfies the predefined low overprovisioning criteria (506—Yes), storage controller determines (508) whether the currently selected non-volatile memory device satisfies predefined valid data criteria.

For example, in some embodiments, during a first pass through all the non-volatile memory devices, non-volatile memory devices having no blocks with an amount of valid data satisfying a first threshold are not selected (508—No) for garbage collection, but non-volatile memory devices having at least one block with an amount of valid data satisfying the first threshold are selected (508—Yes) for garbage collection. If after the first pass through all the non-volatile memory devices, the storage device requires additional garbage collection (e.g., because the number of blocks or superblocks in a spare block pool does not satisfy a target spare block pool size), a second pass through all the non-volatile memory devices is performed (e.g., by performing operations 504-512 for all the non-volatile memory devices in the storage device, or for a subset of those non-volatile memory devices), during which non-volatile memory devices having at least one block with an amount of valid data satisfying a second threshold (e.g., a threshold higher than the first threshold) are selected (508—Yes) for garbage collection.

In various embodiments, execution of the operations in loop 504-512 stops, until a next trigger condition is detected, when: (A) all non-volatile memory devices in the storage device have been processed, or (B) the spare block pool satisfies the aforementioned predefined criteria, or (C) enough garbage collection commands have been sent to respective NMV modules to increase the size of the spare block pool so as to satisfy the aforementioned predefined criteria.

Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Furthermore, each type of memory device may have different configurations. For example, flash memory devices may be configured in a NAND or a NOR configuration.

The memory devices can be formed from passive elements, active elements, or both. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles or a charge storage dielectric material.

Multiple memory elements may be configured so that they are connected in series or such that each element is individually accessible. By way of non-limiting example, NAND devices contain memory elements (e.g., devices containing a charge storage region) connected in series. For example, a NAND memory array may be configured so that the array is composed of multiple strings of memory in which each string is composed of multiple memory elements sharing a single bit line and accessed as a group. In contrast, memory elements may be configured so that each element is individually accessible, (e.g., a NOR memory array). One of skill in the art will recognize that the NAND and NOR memory configurations are exemplary, and memory elements may be otherwise configured.

The semiconductor memory elements included in a single device, such as memory elements located within and/or over the same substrate (e.g., a silicon substrate) or in a single die, may be distributed in a two- or three-dimensional manner (such as a two dimensional (2D) memory array structure or a three dimensional (3D) memory array structure).

In a two dimensional memory structure, the semiconductor memory elements are arranged in a single plane or single memory device level. Typically, in a two dimensional memory structure, memory elements are located in a plane (e.g., in an x-z direction plane) which extends substantially parallel to a major surface of a substrate that supports the memory elements. The substrate may be a wafer on which the material layers of the memory elements are deposited and/or in which memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arranged in non-regular or non-orthogonal configurations as understood by one of skill in the art. The memory elements may each have two or more electrodes or contact lines, including a bit line and a word line.

A three dimensional memory array is organized so that memory elements occupy multiple planes or multiple device levels, forming a structure in three dimensions (i.e., in the x, y and z directions, where the y direction is substantially perpendicular and the x and z directions are substantially parallel to the major surface of the substrate).

As a non-limiting example, each plane in a three dimensional memory array structure may be physically located in two dimensions (one memory level) with multiple two dimensional memory levels to form a three dimensional memory array structure. As another non-limiting example, a three dimensional memory array may be physically structured as multiple vertical columns (e.g., columns extending substantially perpendicular to the major surface of the substrate in the y direction) having multiple elements in each column and therefore having elements spanning several vertically stacked planes of memory devices. The columns may be arranged in a two dimensional configuration (e.g., in an x-z plane), thereby resulting in a three dimensional arrangement of memory elements. One of skill in the art will understand that other configurations of memory elements in three dimensions will also constitute a three dimensional memory array.

By way of non-limiting example, in a three dimensional NAND memory array, the memory elements may be connected together to form a NAND string within a single plane, sometimes called a horizontal (e.g., x-z) plane for ease of discussion. Alternatively, the memory elements may be connected together to extend through multiple parallel planes. Other three dimensional configurations can be envisioned wherein some NAND strings contain memory elements in a single plane of memory elements (sometimes called a memory level) while other strings contain memory elements which extend through multiple parallel planes (sometimes called parallel memory levels). Three dimensional memory arrays may also be designed in a NOR configuration and in a ReRAM configuration.

A monolithic three dimensional memory array is one in which multiple planes of memory elements (also called multiple memory levels) are formed above and/or within a single substrate, such as a semiconductor wafer, according to a sequence of manufacturing operations. In a monolithic 3D memory array, the material layers forming a respective memory level, such as the topmost memory level, are located on top of the material layers forming an underlying memory level, but on the same single substrate. In some implementations, adjacent memory levels of a monolithic 3D memory array optionally share at least one material layer, while in other implementations adjacent memory levels have intervening material layers separating them.

In contrast, two dimensional memory arrays may be formed separately and then integrated together to form a non-monolithic 3D memory device in a hybrid manner. For example, stacked memories have been constructed by forming 2D memory levels on separate substrates and integrating the formed 2D memory levels atop each other. The substrate of each 2D memory level may be thinned or removed prior to integrating it into a 3D memory device. As the individual memory levels are formed on separate substrates, the resulting 3D memory arrays are not monolithic three dimensional memory arrays.

Associated circuitry is typically required for proper operation of the memory elements and for proper communication with the memory elements. This associated circuitry may be on the same substrate as the memory array and/or on a separate substrate. As non-limiting examples, the memory devices may have driver circuitry and control circuitry used in the programming and reading of the memory elements.

Further, more than one memory array selected from 2D memory arrays and 3D memory arrays (monolithic or hybrid) may be formed separately and then packaged together to form a stacked-chip memory device. A stacked-chip memory device includes multiple planes or layers of memory devices, sometimes called memory levels.

The term “three-dimensional memory device” (or 3D memory device) is herein defined to mean a memory device having multiple layers or multiple levels (e.g., sometimes called multiple memory levels) of memory elements, including any of the following: a memory device having a monolithic or non-monolithic 3D memory array, some non-limiting examples of which are described above; or two or more 2D and/or 3D memory devices, packaged together to form a stacked-chip memory device, some non-limiting examples of which are described above.

A person skilled in the art will recognize that the invention or inventions descried and claimed herein are not limited to the two dimensional and three dimensional exemplary structures described here, and instead cover all relevant memory structures suitable for implementing the invention or inventions as described herein and as understood by one skilled in the art.

It will be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific implementations. However, the illustrative discussions above are not intended to be exhaustive or to limit the claims to the precise forms disclosed. Many modifications and variations are possible in view of the above teachings. The implementations were chosen and described in order to best explain principles of operation and practical applications, to thereby enable others skilled in the art.

What is claimed is:

1. A method for operating a storage device having a plurality of NVM modules that each include two or more non-volatile memory devices, the method comprising:
at a storage controller for the storage device:
using status information locally stored in the storage controller with respect to individual NVM modules or individual non-volatile memory devices in the storage device, identifying an NVM module or non-volatile memory device, and sending a garbage collection command to a selected NVM module, the selected NVM module comprising the identified NVM module or the NVM module that includes the identified non-volatile memory device; and
at the selected NVM module:
receiving the garbage collection command sent by the storage controller to the selected NVM module;
in accordance with the received garbage collection command, and in accordance with status information locally stored in the selected NVM module, selecting a memory portion of non-volatile memory in the selected module; and
initiating garbage collection of valid data in the selected memory portion, wherein garbage collection of valid data in the selected memory portion includes copying valid data in the selected memory portion to a target memory portion in the selected module; wherein the status information locally stored in the selected NVM module includes status information with respect to smaller memory portions than the status information locally stored in the storage controller.

2. The method of claim 1, wherein the status information locally stored in the storage controller includes information concerning quantities of unused memory portions in each NVM module or non-volatile memory device in the storage device, the unused memory portions comprising memory portions having no valid data, and identifying an NVM module or non-volatile memory device includes:
comparing information regarding quantities of unused memory portions in each NVM module of two or more NVM modules of the plurality of NVM modules with one or more predefined thresholds, and identifying the NVM module in accordance with an outcome of the comparing.

3. The method of claim 1, wherein the status information locally stored in the storage controller includes information concerning quantities of unused memory portions in each non-volatile memory device in the storage device, the unused memory portions comprising memory portions having no valid data, identifying an NVM module or non-volatile memory device includes:
comparing information regarding quantities of unused memory portions in each memory device of two or more non-volatile memory devices in the storage device with one or more predefined unused memory thresholds, and identifying the non-volatile memory device in accordance with an outcome of the comparison.

4. The method of claim 1, wherein the garbage collection command includes one or more memory portion selection parameters for constraining selection of the selected memory portion by the selected NVM module.

5. The method of claim 4, wherein the status information locally stored in the storage controller includes information concerning quantities of valid data in at least some memory portions in each non-volatile memory device in the storage device, or information concerning quantities of valid data in at least some memory portions in each NVM module of the plurality of NVM modules.

6. The method of claim 4, wherein the one or more memory portion selection parameters includes a valid data parameter, and the selected NVM module, when selecting a memory portion of non-volatile memory in the selected module, selects a memory portion consistent with the valid data parameter.

7. The method of claim 1, wherein the method further includes:
receiving or accessing a host command that specifies an operation to be performed and a logical address corresponding to a portion of non-volatile memory within the storage device;
at the storage controller for the storage device:
mapping the specified logical address to a first subset of a physical address corresponding to the specified logical address, using a first address translation table; and
identifying an NVM module of the plurality of NVM modules, in accordance with the first subset of the physical address;
at the identified NVM module:
mapping the specified logical address to a second subset of the physical address corresponding to the specified logical address, using a second address translation table;
identifying the portion of non-volatile memory within the identified NVM module corresponding to the second subset of the physical address; and
executing the specified operation on the identified portion of non-volatile memory in the identified NVM module.

8. A storage device, comprising:
an interface for coupling the storage device to a host system;
a plurality of NVM modules that each include two or more non-volatile memory devices; and
a storage controller having one or more processors, the storage controller configured to:
identify, using status information locally stored in the storage controller with respect to individual NVM modules or individual non-volatile memory devices in the storage device, an NVM module or non-volatile memory device in the storage device, and sending a garbage collection command to a selected NVM module, the selected NVM module comprising the identified NVM module or the NVM module that includes the identified non-volatile memory device;
wherein the selected NVM module is configured to:
receive the garbage collection command sent by the storage controller to the selected NVM module;
in accordance with the received garbage collection command, and in accordance with status information locally stored in the selected NVM module, select a memory portion of non-volatile memory in the selected module; and
initiate garbage collection of valid data in the selected memory portion, wherein garbage collection of valid data in the selected memory portion includes copying valid data in the selected memory portion to a target memory portion in the selected module; wherein the status information locally stored in the selected NVM module includes status information with respect to smaller memory portions than the status information locally stored in the storage controller.

9. The storage device of claim 8, wherein the storage controller is further configured to identify the NVM module or non-volatile memory device by comparing information regarding quantities of unused memory portions in each NVM module of two or more NVM modules of the plurality of NVM modules with one or more predefined thresholds, and identifying the NVM module in accordance with an outcome of the comparing.

10. The storage device of claim 8, wherein the storage controller is further configured to identify the NVM module or non-volatile memory device by comparing information regarding quantities of unused memory portions in each memory device of two or more non-volatile memory devices in the storage device with one or more predefined unused memory thresholds, and identifying the non-volatile memory device in accordance with an outcome of the comparing.

11. The storage device of claim 8, wherein the garbage collection command includes one or more memory portion selection parameters for constraining selection of the selected memory portion by the selected NVM module.

12. The storage device of claim 11, wherein the status information locally stored in the storage controller includes information concerning quantities of valid data in at least some memory portions in each non-volatile memory device in the storage device, or information concerning quantities of valid data in at least some memory portions in each NVM module of the plurality of NVM modules.

13. The storage device of claim 11, wherein the one or more memory portion selection parameters includes a valid data parameter, and the selected NVM module, when selecting a memory portion of non-volatile memory in the selected module, selects a memory portion consistent with the valid data parameter.

14. The storage device of claim 11, wherein the garbage collection command includes device identifying information that identifies a non-volatile memory device on which to perform a garbage collection operation.

15. The storage device of claim 14, wherein the garbage collection command includes one or more target memory portion selection parameters for constraining selection of the target memory portion by the selected NVM module.

16. The storage device of claim 15, wherein the one or more target memory portion selection parameters includes an age metric or health metric, and wherein the selected NVM module selects the target memory portion of non-volatile memory in the selected module in accordance with the age metric or health metric in the garbage collection command.

17. The storage device of claim 8, wherein
the status information locally stored in the selected NVM module includes valid data quantity information, the valid data quantity information including a respective valid data parameter for each memory portion of a plurality of memory portions in each memory device in the selected NVM module, wherein the respective valid data parameter for a respective memory portion in the selected NVM module indicates a quantity of valid data in the respective memory portion in the selected NVM module; and
the selected NVM module is configured to select a memory portion as the selected memory portion in accordance with the valid data quantity information locally stored in the selected NVM module.

18. The storage device of claim 8, wherein
the status information locally stored in the selected NVM module includes age or health information locally stored in the selected NVM module, the age or health information including an age metric or health metric for each memory portion of a plurality of memory portions in each memory device in the selected NVM module, wherein the respective age metric or health metric for a respective memory portion in the selected NVM module indicates a measurement of age or health of the respective memory portion in the selected NVM module; and
the selected NVM module is configured to select a memory portion as the target memory portion in accordance with the age or health information locally stored in the selected NVM module.

19. The storage device of claim 8, wherein the storage controller is configured to update the status information locally stored in the storage controller with status information received from a respective NVM module of the plurality of NVM modules.

20. The storage device of claim 19, wherein
the storage controller is configured to send a status update request to a respective NVM module of the plurality of NVM modules; and
the respective NVM module is configured to send to the storage controller, in response to receiving the status update request, status information based on status information locally stored in the respective NVM module.
